(19) United States
(12) Patent Application Publication
(10) Pub. No.: US 2006/0187484 A1
(43) Pub. Date: Aug. 24, 2006

(54) Printing process control apparatus, program, recording medium and printing process control method for controlling process of printing process control apparatus

(75) Inventor: Akihiko Noda, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/350,944

(22) Filed: Feb. 10, 2006

(30) Foreign Application Priority Data
Feb. 18, 2005 (JP) 2005-042526

(51) Int. Cl. G06F 3/12

(52) U.S. Cl. 358/1.15; 358/1.13

(57) ABSTRACT

A printing process control method for controlling a printing process control apparatus, program, recording medium and process of the printing process control apparatus analyzes order data for designating the number of prints of an original to be printed by a printer and a post-processing condition, divides the order data into a plurality of processing process jobs, assigns the divided plurality of processing process jobs as printing by the printer and the post-processing by the post-processing apparatus and decides a schedule. Moreover, the schedule decision decides a schedule so that a combination of the printing by the printer and the post-processing by the post-processing apparatus is repeatedly performed.

### BACKGROUND OF THE INVENTION

1. Field of the Invention

The present invention relates to a printing process control apparatus, program, recording medium and printing process control method for controlling the process of the printing process control apparatus.

2. Related Background Art

Conventionally, a commercial printing dealer who generates printed matter in accordance with a request from a customer such as an individual user or enterprise is present. This printing dealer receives printing data (original) and designations of a printing format, the number of copies and delivery date from a customer, prepares printed matter and delivers the printed matter to the customer. This printing dealer performs business activities by using a large machine such as a well-known offset prepress printing machine.

Moreover nowadays, a corporate structure of commercial printing such as “copy service”, “printing service” or Print On Demand (POD) center is present which can be output and delivered in a short time in accordance with the change of an electrophotographic printer (hereafter referred to as printer) or ink-jet-type printer to high speed or high image quality.

In the case of requests for printing to these printing businesses, an original recorded in a sheet or electronic medium (FD, MO or CD-ROM) and printing instruction (order instruction) in which the number of copies of the original, binding method, delivery date or the like are recorded are sent to a printing company through mailing or directly brought to the printing company.

Moreover, a system is practically used which can place or receive an order for copies by on-line through Internet or Intranet. A printing dealer receives a request from a user to prepare a printing instruction. Then, the dealer performs printing and book binding by a printer connected to a work computer in accordance with the printing instruction and delivers prepared printed matter to a customer and the business is completed.

The printing dealer for executing the printing entrusted from a user must complete the printing so as to securely be in time for a specified delivery date at a stable quality. Moreover, in the case of a large-scale printing center, a plurality of operators must sequentially process many printing requests (printing orders) in parallel by using various types of printers and work computers. Therefore, it is necessary to make the most use of resources such as persons (operator for performing work) and apparatuses as efficiently as possible. That is, it is important to form a plan (schedule) of a job capable of maximally making the most use of resources in keeping with a delivery date and cost.

In the case of the prior art, a conformation in which jobs are scheduled in the sequence based on the delivery date of a printing request (printing order) is frequently used. However, in the case of the method for scheduling jobs in the sequence based on the delivery date of the printing order described above, when there is the processing having a high work load (time) such as “book binding” or “cutting” shown in FIG. 1 in the post process different from the printing process, there is a problem that jobs are concentrated on the final process and the work efficiency of the whole processing is lowered.

Nowadays, to solve the above problem, Japanese Patent Application Laid-Open No. 2003-029956 discloses a technique for calculating the time required for printing performed in a printing process or finishing (post process) such as “book binding” or “cutting” in the post process and scheduling a optimum processing sequence in accordance with the calculated time.

In the case of a conventional scheduling system, only mechanical throughput (operating rate) of the post process such as off-line finisher is used for the mechanical throughput (operating rate) of the printing process of a printer and delivery date of a job (printing order) as a determination processing of scheduling jobs.

Therefore, when preparing a lot of printed matter, scheduling is performed in order of process so that all outputs are simultaneously executed. Moreover, when post-process processing such as book binding machine or cutting machine requiring a lot of work time after printing is necessary, the work flow is obtained in which a lot of printed matter is loaded/left as they are for a long time as shown in FIG. 2.

The above-described work flow according to the prior art has no problem for a normal job. However, in the case of the order (secure job) in which security protection, consideration for information leak and concealment property are requested on the content of printed matter from a customer, the same work flow has a problem on security because printed matter is loaded/left as they are for a long time and may be read by an unspecified number of persons other than the operator in charge. For example, in the case of the work flow of the prior art, a problem state occurs because loading or leaving time is further extended when the printing completion time is lunch break or after the fixed hour because of the working time of an operator, the schedule of other job is delayed or changed, the use start of a post-process device is delayed or the post-process device is broken down though the device in the printing process can be executed.

### SUMMARY OF THE INVENTION

It is an object of the present invention to provide a printing process control apparatus, program, recording medium and printing process control method for controlling the process of the printing process control apparatus which can solve above-described problem.

To solve the above-described problem, a printing process control apparatus of the present invention uses a printing process control apparatus for controlling a printing process by a printer and post-processing process by a post-processing apparatus, in which storage means for storing throughputs of the printer and the post-processing apparatus, job division means for analyzing order data for designating the number of copies of an original to be printed by the printer and post-processing condition, reading each of the throughputs of the printer and post-processing apparatus and dividing the order data into a plurality of jobs in accordance with the read throughputs and schedule means for scheduling the printing and the post-processing for each of the jobs so that the printing by the printer and the post-processing by the post-processing apparatus are continuously applied to each job divided by the job division means are included.

To solve the above-described problem, an information control method for controlling a process of a printing process control apparatus of the present invention uses a printing process control method for controlling the process of a printing process by a printer and a post-processing process by a post-processing apparatus, in which the following steps are included: a storing step of storing each of throughputs of the printer and post-processing apparatus, a job division step of analyzing order data for designating the number of copies of an original to be printed by the printer and post-processing condition, reading each of the throughputs of the printer and post-processing apparatus and dividing the order data into a plurality of jobs in accordance with the read throughputs and a schedule step of scheduling the printing and post-processing for each of the jobs so that the printing by the printer and the post-processing by the post-processing apparatus are continuously applied to each job divided in the division step.

To solve the above-described problem, a program of the present invention uses a program for controlling the process of a printing-process control apparatus for controlling a printing process by a printer and a post-processing process by a post-processing apparatus, in which a computer is made to function as storage means for storing each of throughputs of the printer and post-processing apparatus, job division means for analyzing order data for designating the number of copies of an original to be printed by the printer and post-processing condition, reading each of the throughputs of the printer and post-processing apparatus and dividing the order data into a plurality of jobs in accordance with the read throughputs and schedule means for scheduling the printing and the post-processing for each of the jobs so that the printing by the printer and post-processing by the post-processing apparatus are continuously applied to each job divided by the division means.

To solve the above-described problem, a recording medium of the present invention stores a program for controlling the process of a printing-process control apparatus for controlling a printing process by a printer and a post-processing process by a post-processing apparatus, in which a computer is made to function as storage means for storing each of throughputs of the printer and post-processing apparatus, job division means for analyzing order data for designating the number of copies of an original to be printed by the printer and post-processing condition, reading each of the throughputs of the printer and post-processing apparatus and dividing the order data into a plurality of jobs in accordance with the read throughputs and schedule means for scheduling the printing and the post-processing for each of the jobs so that the printing by the printer and the post-processing by the post-processing apparatus are continuously applied to each of the jobs divided by the division means.

Other features and advantages of the present invention will be apparent from the following description taken in conjunction with the accompanying drawings, in which like reference characters designate the same or similar parts, throughout the figures thereof.

### BRIEF DESCRIPTION OF THE DRAWINGS

FIG. 1 is a schematic view showing an example of a post process in the prior art;

FIG. 2 is a schematic view showing work flows of a printing process and post-process in the prior art;

FIG. 3 is a schematic block diagram of an embodiment of a printing process control apparatus of the present invention;

FIG. 4 is a block diagram showing a schematic configuration of a client PC in FIGS. 3 and 11;

FIG. 5 is an illustration showing a memory map for the data of an FD in FIG. 4;

FIG. 6 is an illustration showing a memory map when expanding a program from the FD shown in FIG. 5 on the RAM in FIG. 4;

FIG. 7 is a flowchart showing a data processing procedure in a printing process control apparatus of the present invention;

FIG. 8 is a flowchart showing a data processing procedure in a printing process control apparatus of the present invention;

FIG. 9 is a flowchart showing a data processing procedure in a printing process control apparatus of the present invention;

FIG. 10 is a flowchart showing a data processing procedure in a printing process control apparatus of the present invention;

FIG. 11 is a block diagram of an embodiment of a printing process control apparatus of the present invention;

FIG. 12 is a schematic view showing an order list dialog of an embodiment;

FIG. 13 is a schematic view showing a job list dialog of an embodiment;

FIG. 14 is an illustration showing a printing designation dialog of an embodiment;

FIG. 15 is an illustration showing a warning dialog of an embodiment;

FIG. 16 is an illustration showing a secure job processing setting dialog of an embodiment;

FIG. 17 is an illustration showing a device scheduler in the prior art;

FIG. 18 is an illustration showing a device scheduler of an embodiment;

FIG. 19 is comprised of FIGS. 19A and 19B showing illustrations of an order information table of an embodiment;

FIG. 20 is an illustration showing a device schedule information table of an embodiment;

FIG. 21 is an illustration showing a device ability information table of an embodiment;

FIG. 22 is an illustration showing processing time of an embodiment;

FIG. 23 is an illustration showing a notice dialog of an embodiment;

FIG. 24 is an illustration showing a job information table of an embodiment;

FIG. 25 is an illustration showing processing time of an embodiment;

FIG. 26 is an illustration showing a wrapping information table of an embodiment;

FIG. 27 is an illustration showing a process sequence and loading time when division units are different from each other by comparing them;

FIG. 28 is an illustration showing the division mode and processing time of a job of an embodiment;

FIG. 29 is an illustration showing process sequences and loading times of an embodiment and prior art by comparing them;

FIG. 30 is an illustration showing process sequences and loading times of an embodiment and prior art by comparing them;

FIG. 31 is an illustration showing process sequences and loading times of an embodiment and prior art by comparing them; and

FIG. 32 is an illustration showing division mode and processing time of a job of an embodiment.

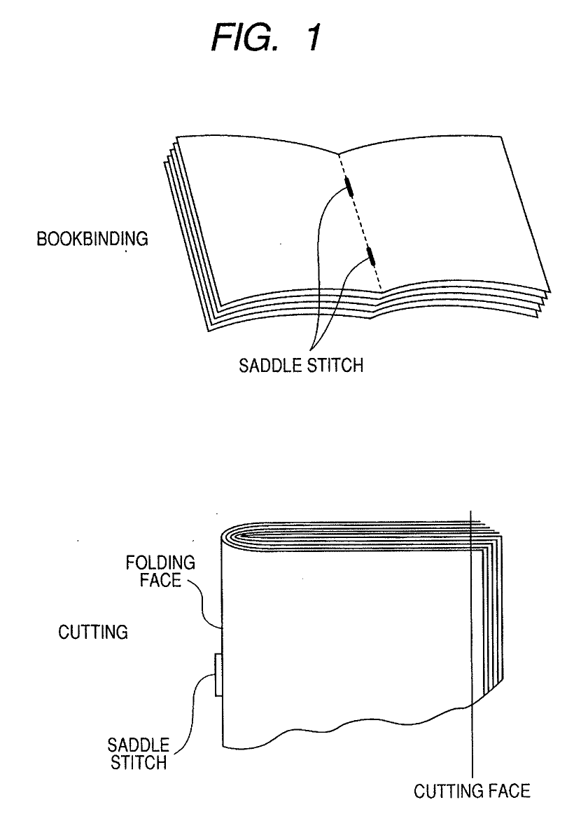

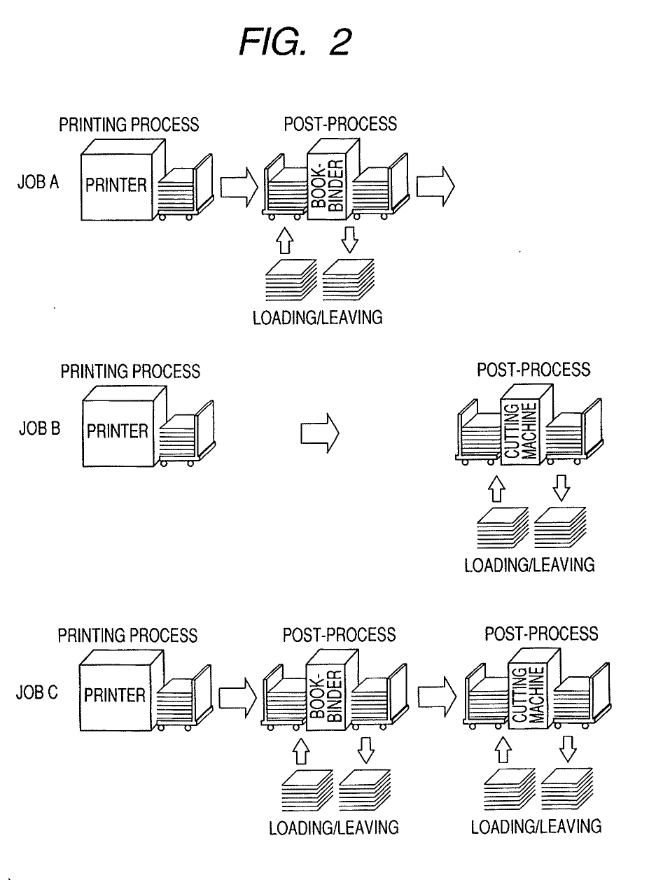

### DETAILED DESCRIPTION OF PREFERRED EMBODIMENTS

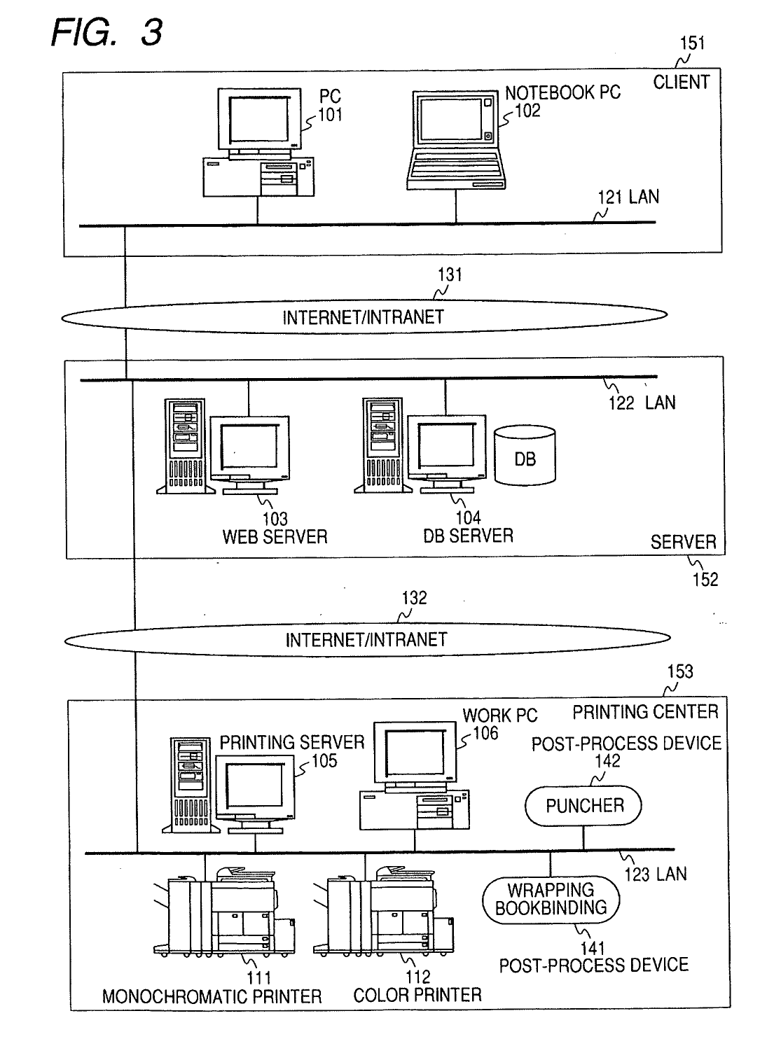

FIG. 3 is an illustration showing the general configuration of an embodiment of a printing system of the present invention. Environments of the whole of the printing system in the following description are used to make the description of the present invention understandable. Therefore, the present invention is not restricted to these environments.

In FIG. 3, a client 151 shows that a notebook PC 102 Internet-connected or company-Intranet-connected PC 101 for business use constructed by LAN 121 or the like are set in the house of a general user.

A server 152 shows a server in which a WEB server 103 for providing receiving contents for receiving a printing request or original from a user and DB server (Data Base Server) 104 for storing a received printing request as an order sheet or an electronically-received original are arranged. In this case, it is possible to set the WEB server 103 and DB server 104 in one housing. However, in the case of the present invention, it is assumed that the WEB server 103 and DB server 104 are separately set in two housings for convenience' sake and they are connected by LAN 22 or the like.

A plurality of printing centers 153 can be present for the server 152 and printing orders are divided into any printing center by the server 152 in accordance with the information on printers set in the printing center 153. The printing center 153 regularly collects order sheets and originals accumulated in the server 152 from the DB server 104. A printing server 105 in which a system of the present invention operates, work PC 106 for operating various types of services provided by the printing server 105 by using an easy-to-use GUI, monochromic printer 111 and color printer 112 serving as actual output destinations and post-process device 141 (wrapping bookbinder) and post-process device 142 (puncher machine) which are used after printing are arranged in the printing center 153 and they are connected by LAN 123 or the like. The configuration and environment of the printing center 153 are not restricted to the above mentioned.

In the case of this embodiment, the client 151 and server 152 are network-connected each other by Internet or Intranet 131. The server 152 and the printing center 153 are network-connected each other by Internet or Intranet 132. A client and server are normally frequently connected each other by Internet and the server and a printing center are frequently Internet-connected each other by using a dedicated line. However, the present invention can be applied not only in this environment but also in an environment in which a server is present in a printing center.

A browser for browsing receiving contents provided by the WEB server 103 is mounted on the notebook PC 102 and PC 101 of the client 151. Though a browser generally uses Internet Explorer (registered trademark) made by MicroSoft (registered trademark) Inc., it is also allowed to use NetScape (registered trademark) made by NetScape (registered trademark) Inc or the like. Moreover, it is possible to upload original data by using the receiving contents.

The WEB server 103 provides the receiving contents. The receiving contents include printing settings such as a printing format of book binding, number of copies, sheet size and delivery date, requester information and edit control for inputting a distribution destination and file designation control for uploading original data. In this case, rate calculation according to input request content and settlement of input items are realized in a service module operating on the WEB server 103. The rate calculation and the settlement are general logics and are not directly related with the present invention. Therefore, the description is omitted. Moreover, the WEB server 103 stores a printing request decided by the designation input from the client 151 in an order sheet (printing request contents and the file name of original data are entered in the order sheet) and an original data file in the DB server 104.

A general database such as OracleDatabase (registered trademark) made by Oracle (registered trademark) Inc. is installed in the DB server 104. The DB server 104 can transmit a desired order sheet and original data in accordance with a data obtainment request to be described later from the printing server 105. A DB schema (not illustrated) is mainly constituted of a printing center master (having the information on a place and communication destination, device master and bookbinding master as members), device master (device configuration information on color/monochromatic, number of printing sheets and option) table and post-process device master (information on wrapping bookbinder machine and puncher machine) table. By referring to these tables, the printing server 105 in the printing center 153 can receive an order assigned to the center of its own.

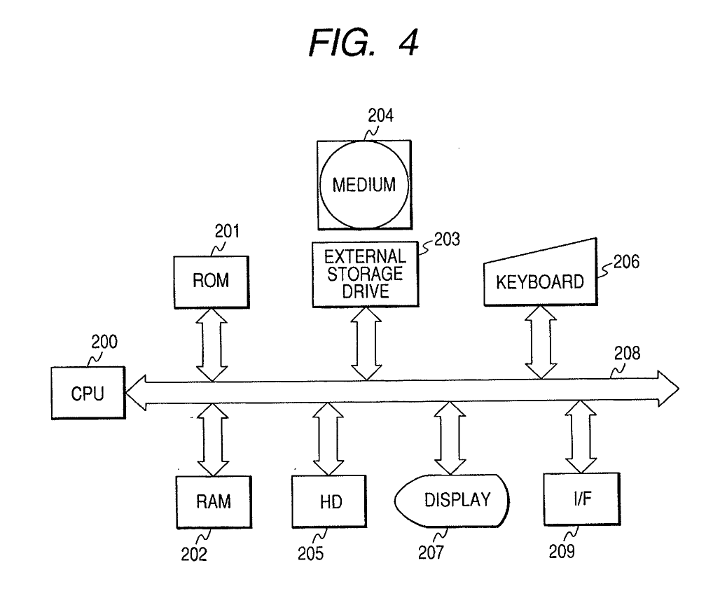

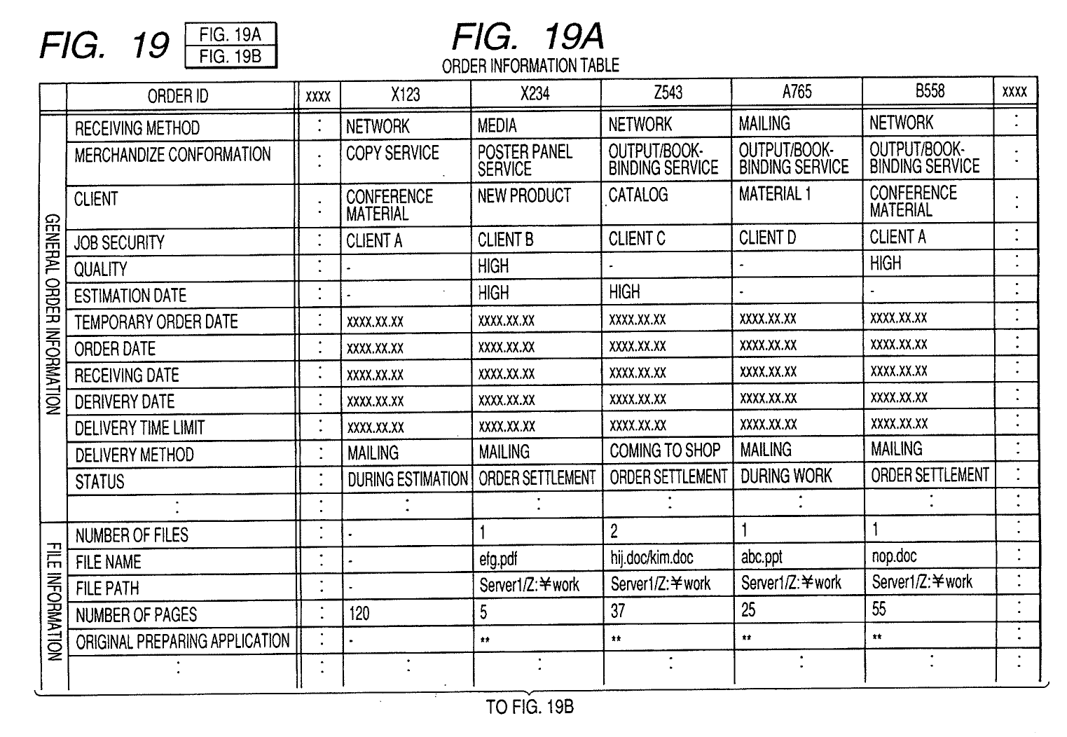

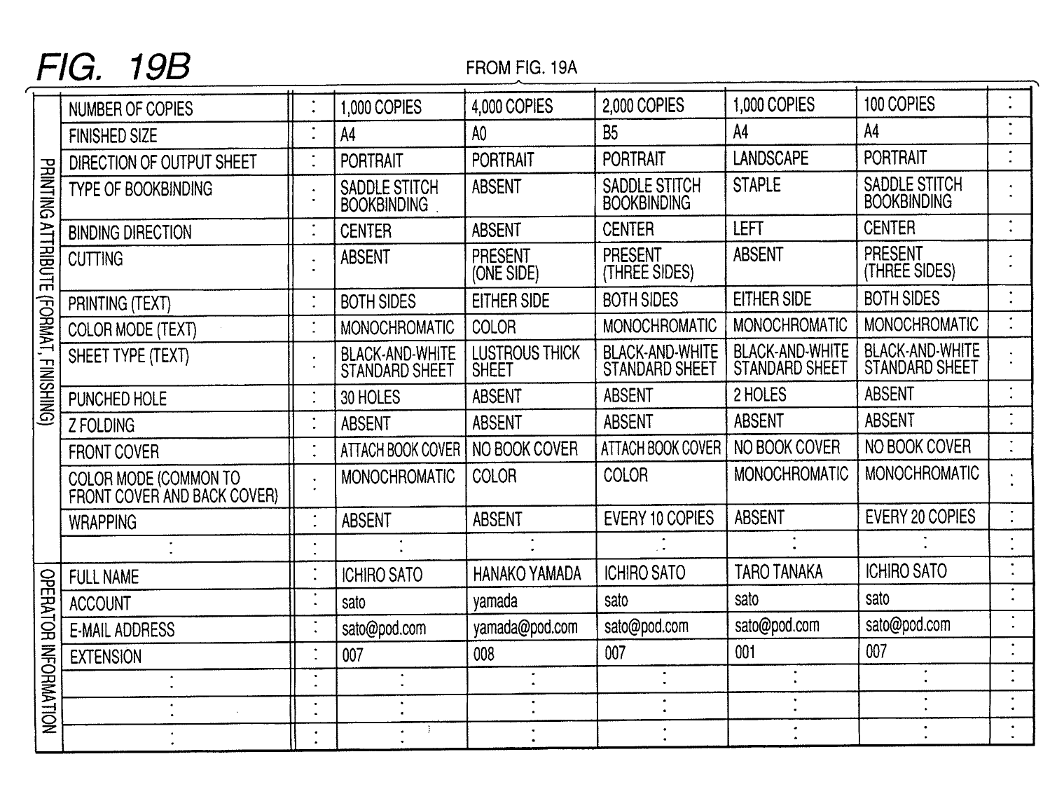

When the printing server 105 communicates with the WEB server 103 and receives order sheets and original data from the DB server 104, the server 105 prepares an order information table according to received data and stores the table in a HD 205 in the printing server 105 shown in FIG. 4. The content of the order information table will be described later together with FIGS. 19A and 19B.

The printing server 105 receives a notice of Corder decision from the WEB server 103, collects order sheets and original data file from the DB server 104 and a printing system which operates in accordance with collected order sheets starts working.

The work PC 106 is a work computer having a console for controlling various services provided by the printing server 105 by using an easy-to-use operation screen, fetching an original data file from the printing server 105, starting a predetermined application, preparing a printing format and capable of performing printing in accordance with specified printing setting.

The monochromatic printer 111 and color printer 112 are different from each other in setting configuration depending on a printing center. However, a configuration in which a high-speed monochromatic printer and a high-quality color printer are combined is generally frequently used. These printers are all scheduled by a printing system using the printing server 105.

The post-process devices 141 and 142 are, machines for post-processing sheets output from the monochromatic printer 111 and color printer 112, which are wrapping bookbinders, punchers, staplers or ring bookbinders. The post-process devices 141 and 142 can collect situation statuses by connecting them to a network. In the case of the post-process devices 141 and 142, setting configuration depends on a printing center similarly to the above printer. However, even in the case of an environment in which they are not network-connected, it is possible to apply the present invention and the present invention is not restricted to the above environment.

FIG. 4 is a block diagram showing a schematic configuration of the WEB server 103, DB server 104, printing server 105 and work PC 106.

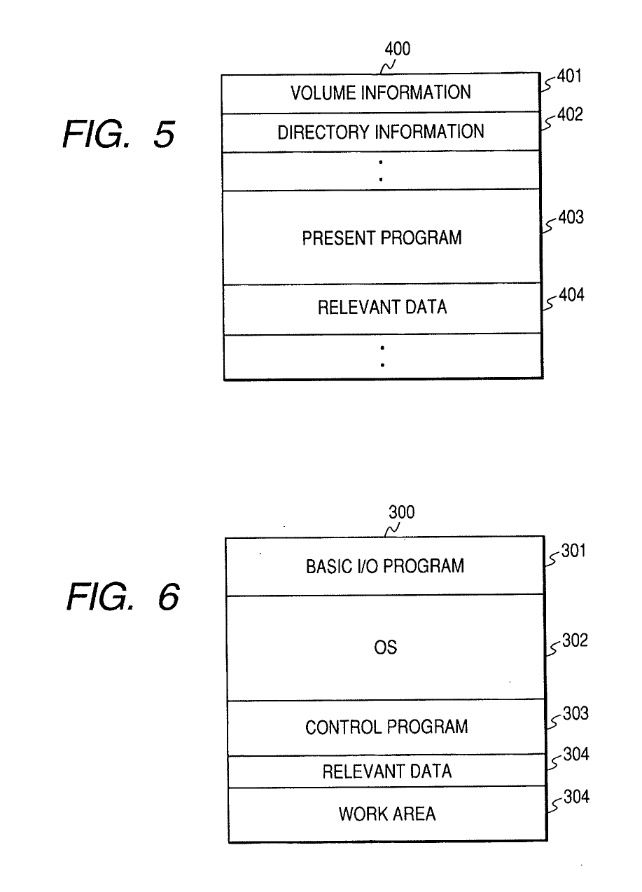

A CPU 200 performs the control for executing an application program, printer driver program, OS and network printer control program stored in an HD (hard disk) 205 and temporarily storing the information, files and the like necessary for execution of programs in a RAM 202. A ROM 201 stores a program such as a basic I/O program and various types of data such as font data used for document processing and data for a template. The RAM 202 functions as the main memory, work area and the like of the CPU 200. An external storage drive 203 can load a program or the like stored in a medium 204 to the present computer system. The medium 204 stores a program described for this embodiment and relevant data. FIG. 5 shows the configuration of the stored contents. The HD 205 stores an application program, printer driver program, OS, control program, relevant programs and the like. A keyboard 206 is used for a user to input a device control command to a client computer. A display 207 displays a command input from the keyboard 206, the state of a printer and the like. A system bus 208 controls the flow of data in the client computer. A network interface. (hereafter referred to as I/F) 209 is a communication interface to be connected to a local area network (LAN) or Internet.

FIG. 6 shows a memory map of a state in which a program of the present invention is loaded to the RAM 202 and ready for execution.

This embodiment shows an example of directly loading a program and relevant data from a medium 204 to the RAM 202 and executing them. However, it is also allowed to load a program of the present invention from the HD 205 to the RAM 202 whenever operating a program of the present invention from the medium 204. Moreover; it is allowed that the medium 204 serving as a medium for recording a program of the present invention is an FD; CD-ROM, DVD, IC memory card or the like. It is also possible to record a program of the present invention in the ROM 201 and constitute this so as to be a part of a memory map and directly execute the program by the CPU 200. A basic I/O program 301 has an area having therein a program having an IPL (initial program loading) function for starting operations of an OS when the OS is read in the RAM 202 from the HD 205 when the control device is powered on. An OS is developed in 302, a control program is developed in 303 and relevant data is developed in 304. A work area 305 is an area used for the CPU 200 to execute the present program.

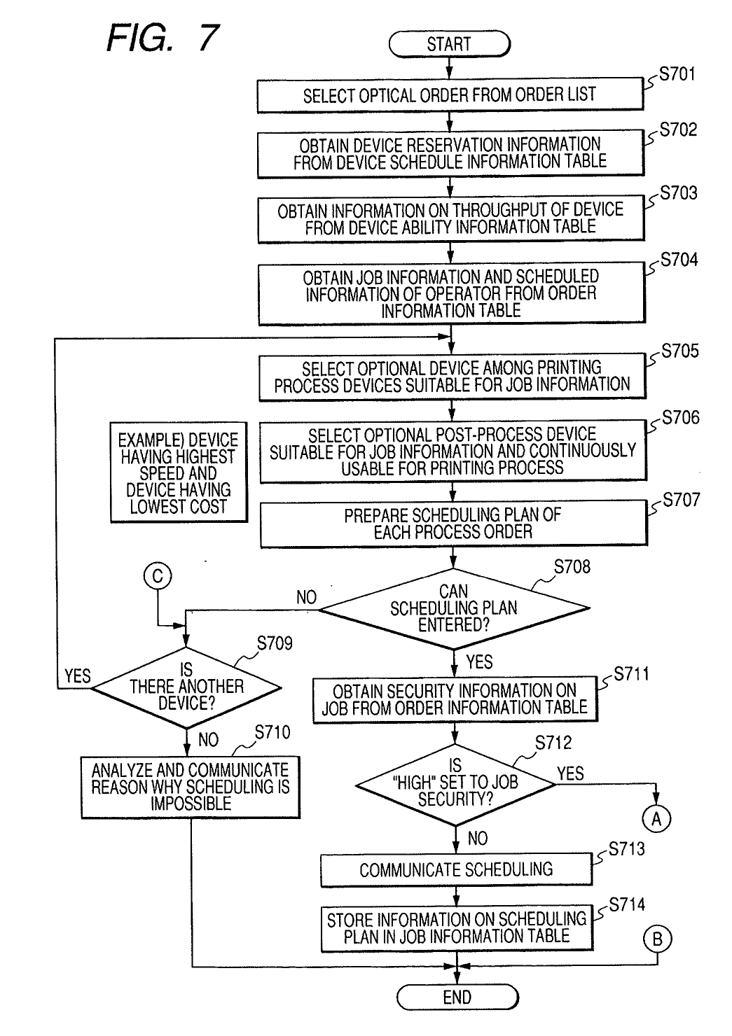

In FIG. 5, reference numeral 400 denotes the data content of the medium 204, 401 denotes volume information showing the information of data, 402 denotes directory information, 403 denotes a program described for this embodiment and 404 denotes the relevant data of the program. The program 403 is program-coded in accordance with the flowchart of the present program to be described later by referring to FIGS. 7 to 10.

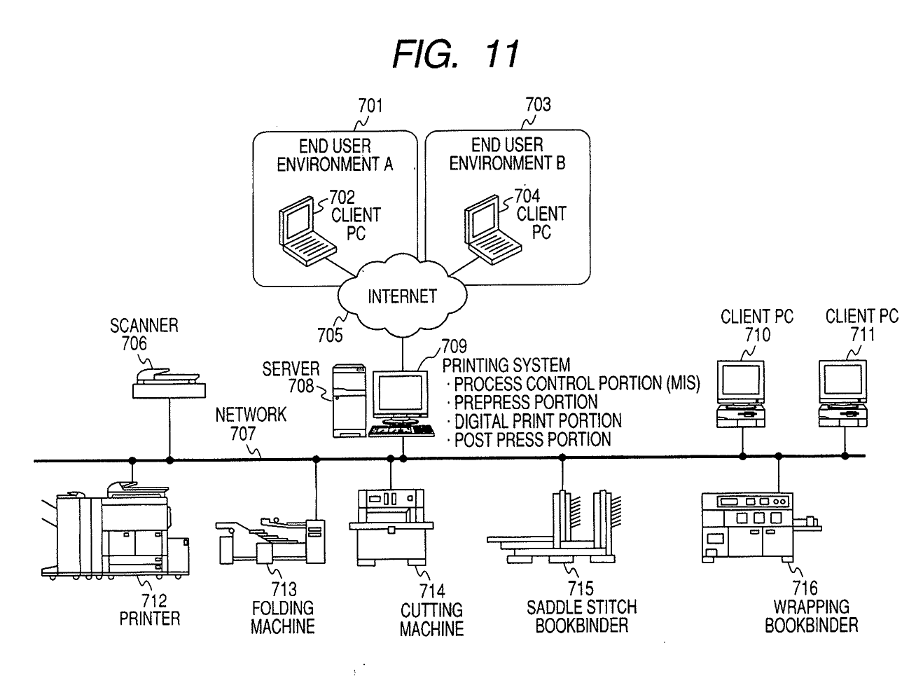

FIG. 11 is a block diagram showing a printing process device (printer) and post-process devices (folding machine, cutting machine, saddle-stitch bookbinder, wrapping bookbinder etc) constituting a system of the present invention.

A printing server 708 which is the printing server 105 in the environment of the printing center 153 constitutes a printing system 709 (also referred to as printing process control apparatus) having a function for executing four processes of a process control portion, prepress portion, digital print portion (printing process) and post press portion (post-processing process).

One of main functions of the process control portion is the function of a system for collecting and analyzing the information necessary for decision making of management and control of an enterprise referred to as a control information system or management information system (MIS). In general, the MIS is a system for totally controlling various management information and sales information including advertisement, order acceptance, estimation, planning, production, shipping, inventory, purchasing and selling. Particularly, the MIS in the printing business world has an aspect as a printing production process control system. The MIS in the printing business world consolidates printing production facilities and printing production resources and provides a mechanism for automating the total work flow from order acceptance to delivery or cost recovery by a job ticket showing a work designation in a job referred to as JDF (Job Definition Format).

The prepress portion scans a sheet original received from an end user by a scan device such as scanner 706 or printer 12, captures the original as a scan image file and executes image correction such as oblique correction or black point removal. Moreover, the prepress portion executes various types of page layout editions and printing such as margining of a plurality of documents or image files received from an end user or a plurality of scan image files scanned by a scan device, inserting or deleting of a page, adding a page number or annotation, inserting index paper, book cover or inserting paper and designating of Nin-1 printing or multiple printing.

The digital print portion performs the control for outputting to any device or clustering any device (mode for executing the printing operation of a job output from one image data generation source by a plurality of image forming apparatuses in parallel and simultaneously). The digital print portion sends printing data to the interface of a selected device and control the printing, transmission and the like by the device so that it can be executed.

The post press portion controls sheet working apparatuses such as a cutting machine, saddle stitch machine, wrapping bookbinder, folding machine, inserting machine and balancing machine so as to apply post-processing (finishing) requested by a user (client) (sheet working applied to recording sheets in the cutting process, saddle stitch bookbinding process, wrapping book binding process, folding process, inserting process, and balancing process) to the recording sheets printed by an image forming a apparatus such as the above printer.

As shown in FIG. 11, the printing system 709 is constituted of one server 708 and a plurality of client PC 710 and 711 and it is also possible to constitute the system 709 by a plurality of servers and a plurality of client PCs instead.

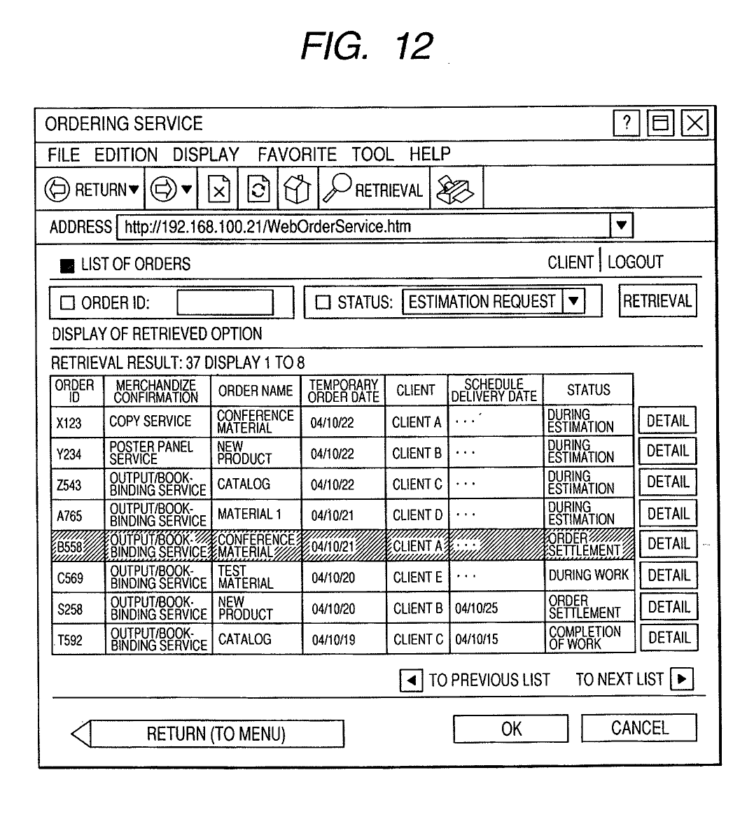

FIG. 12 is an illustration showing an example of a setting screen configuration for confirming a list of orders of the above printing system.

In the case of “list of orders”, it is possible to retrieve an order to be displayed by inputting the order ID of the order to be displayed to an “order ID” edit box, setting the check box to a selection sate and/or selecting the status of the order to be displayed by a “status” pull-down list box, setting the check box to a selection state and then pressing “retrieval” button.

In the case of “retrieval option display”, the retrieval condition of an order when pressing the “retrieval” button is displayed. In the case of “retrieval result”, all retrieved orders and the number of displays at present are displayed and various information in retrieved orders such as “order ID”, “merchandise conformation”, “order name”, “temporary order date”, “requester”, “scheduled delivery date” and “status” are displayed as a list of orders. By pressing a “detail” button, more detailed information on a designated order is displayed.

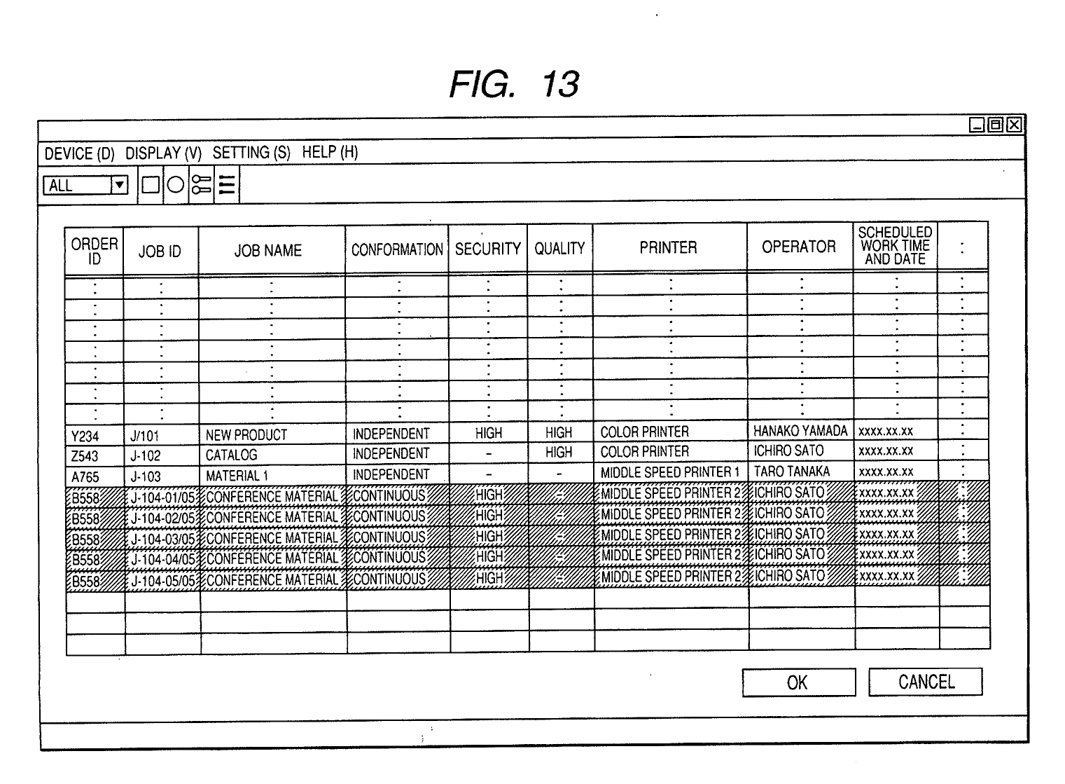

FIG. 13 is an illustration showing an example of a setting screen configuration for confirming the list of jobs schedule-reserved for an order in the above printing system.

As the list of jobs, various information such as “order ID”, “conformation”, “security”, “product quality”, “printer”, “operator” and “scheduled work time and date” are displayed.

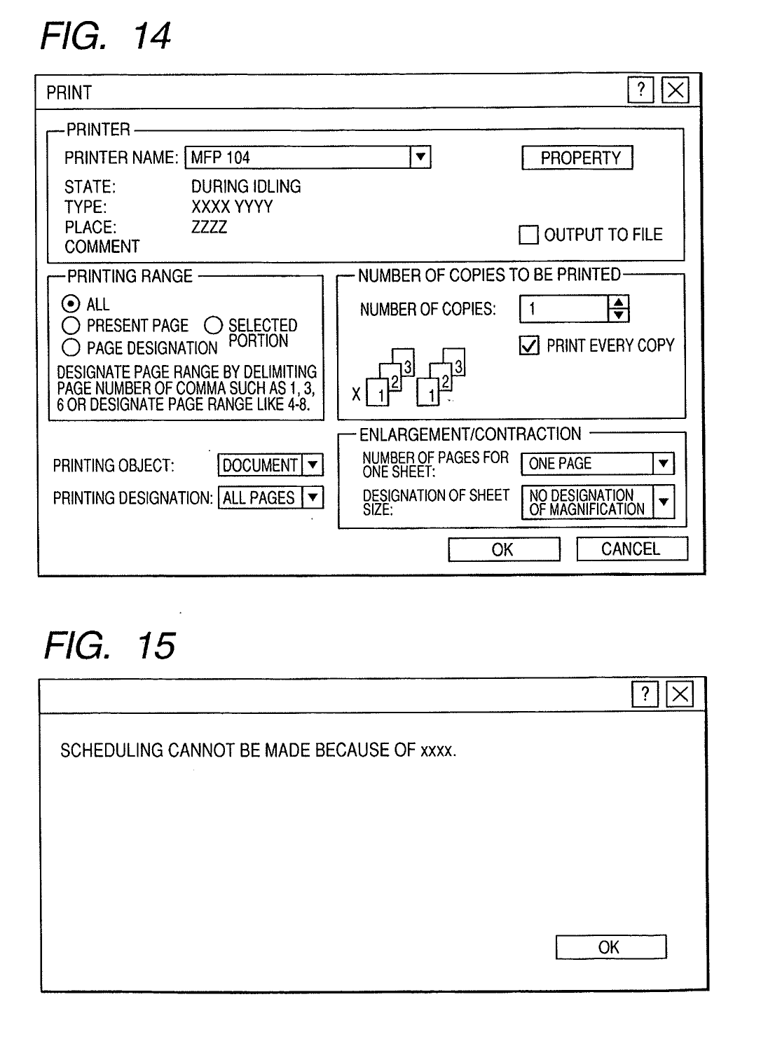

FIG. 14 is an illustration showing an example of a printing-designation setting screen configuration which is one means for proof-outputting data from a printing application of the above printing system to a printing process device such as a printer or outputting final results.

When an operator completes setting of setting screen and pressing an “OK” button, it is possible to output printing data to a printing process device or file.

FIG. 15 is an illustration showing a screen configuration when communicating information to an operator of the above printing system.

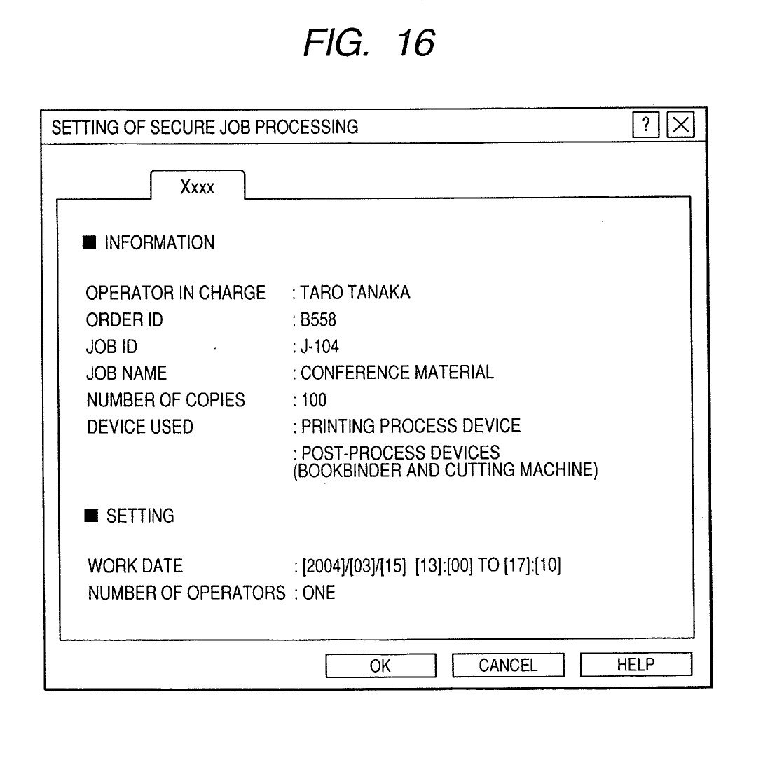

FIG. 16 is an illustration showing a setting screen configuration for displaying the information on a secure job of the above printing system and inputting the work time and date of operators and the number of operators working at the same time.

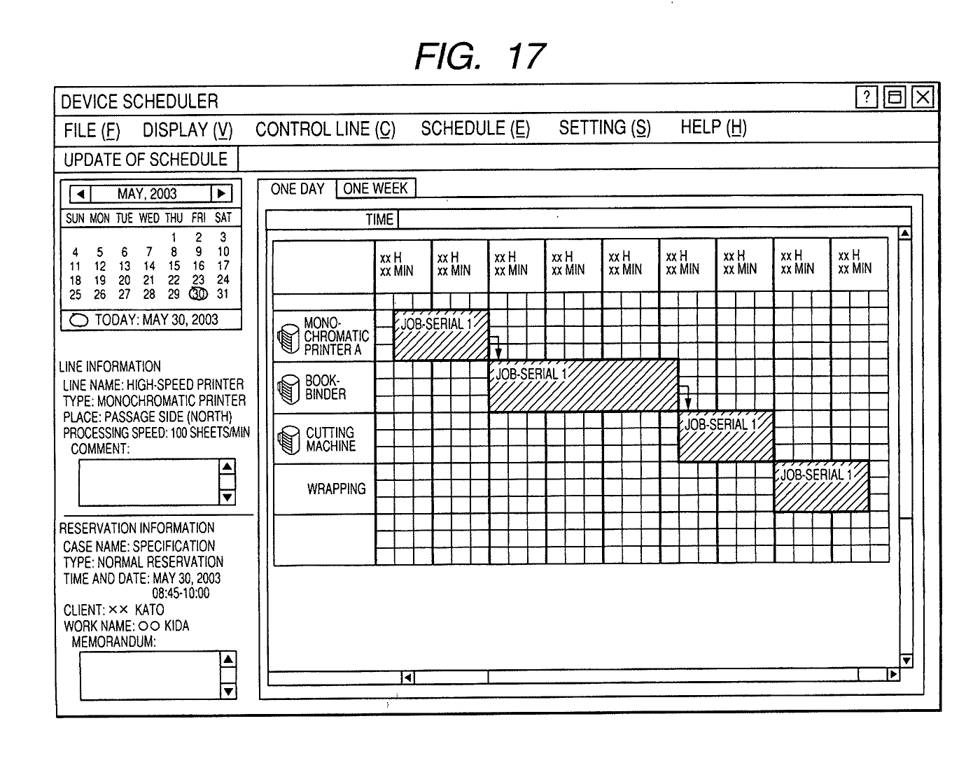

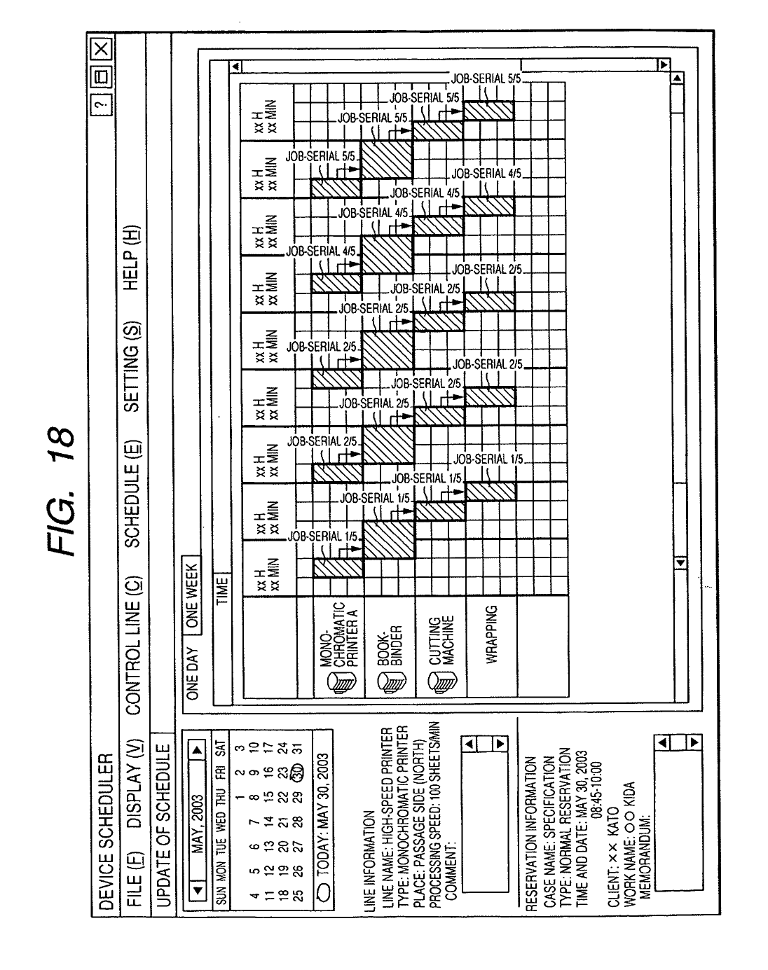

FIGS. 17 and 18 are illustrations respectively showing an example of a device-scheduler setting screen configuration for displaying the information on schedule situation of a device of the above, printing system. FIG. 17 shows a case of displaying the information on a schedule situation in a work flow performed by a prior art and FIG. 18 shows a case of displaying the information on a schedule situation in a scheduling plan by a division conformation of the present invention.

Hereafter, the flow of scheduling of the present invention is described.

The general flow of scheduling and a method for scheduling a normal job which is not a secure job are described by referring to the flowchart shown in FIG. 7.

The printing system 709 shown in FIG. 11 (hereafter referred to as printing process control apparatus) displays the order list dialog shown in FIG. 12 by referring to the order information table shown in FIG. 19 stored in the HD 205 of the server 708. When an operator designates an optional order to be worked hereafter in the order list dialog, the printing process control apparatus 709 selects the designated order (step S701). In this case, it is assumed that the order (job) of “order ID:B558” is selected. “High” is set to this order as a job security attribute. This order becomes a job using a printing process device and post-process device because of merchandize conformation:output or bookbinding service, order name:conference material, status:order established, number of pages:55, number of copies:100, finished size:A4, type of bookbinding: saddle stitch bookbinding, cutting:used (three directions), color mode: monochromatic; and wrapping unit:20 copies.

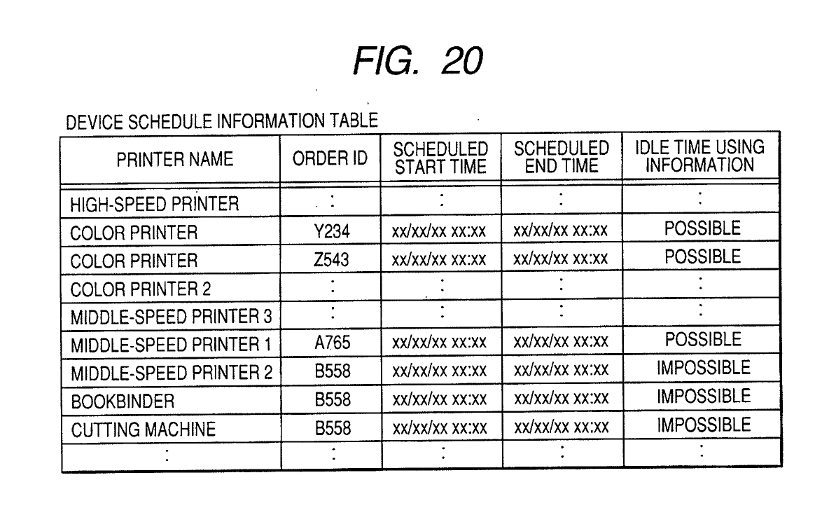

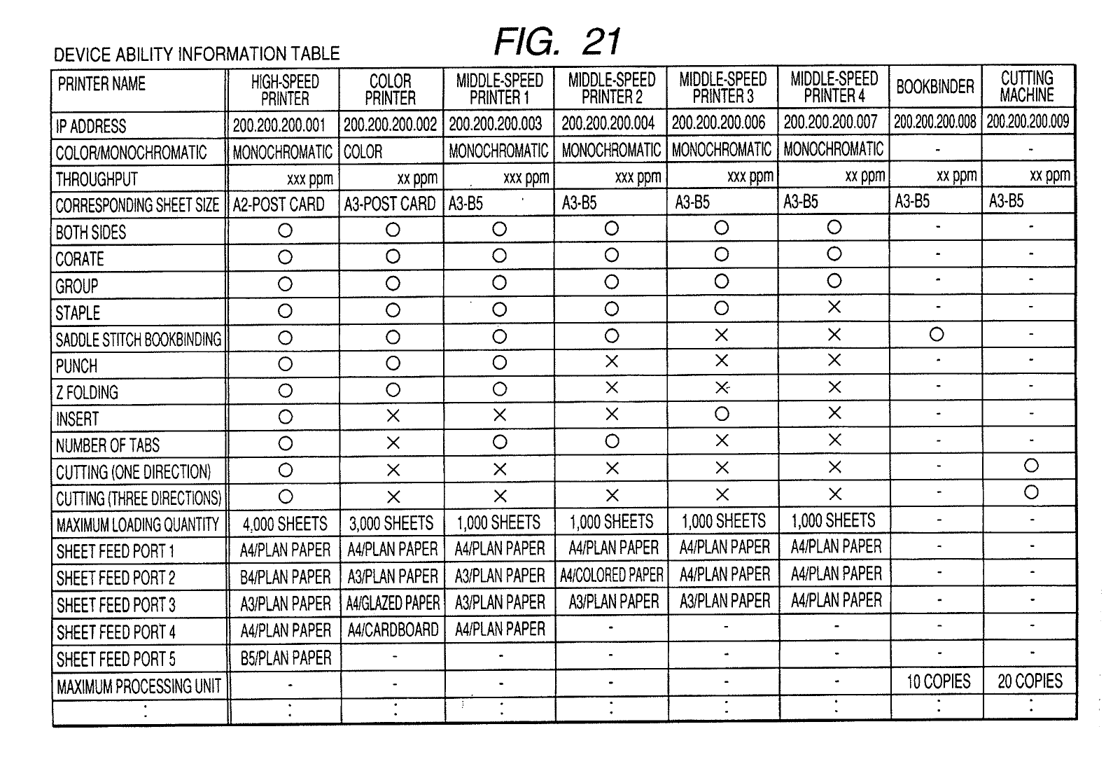

Then, the printing process control apparatus 709 obtains the reservation information of devices by referring to the device schedule information table shown in FIG. 20 to hold the information (S702). Then, the printing process control apparatus 709 obtains throughput information of devices by referring to the device ability information table shown in FIG. 21 to hold the information (S703). Then, the printing process control apparatus 709 obtains job information and operator schedule information by referring to the order information table (FIG. 19) to hold the information (S704).

Then, the printing process control apparatus 709 selects an optional device among printing process 20 devices suitable for job information (S705). For example, the apparatus 709 selects a printing process device such as a device whose processing speed is the highest or a device whose cost is lowest in accordance with the setting of the printing system 709.

The printing process control apparatus 709 selects an optional post-process device which is suitable for job information and can be continuously used for a printing process (S706). For example, the apparatus 709 selects a post-process device such as a device whose processing speed is the highest or a device whose cost is the lowest in accordance with the setting of the apparatus 709.

The printing process control apparatus 709 prepares a scheduling plan in order of each process from the information on a selected printing process device and post-process device (S707). In this case, scheduling in order of each process denotes the process shown in FIG. 17 which is a work flow conformation performed for a prior art. In the case of this scheduling, 100 copies which is a designated number of copies are first printed by a printing process device (monochromatic printer A) as a job lot. Then, the saddle stitch bookbinding which is a post-process is applied to 100 copies by a bookbinder as a job lot, cutting is applied to 100 copies by a cutting machine as a job lot and wrapping is applied to 100 copies as a job lot.

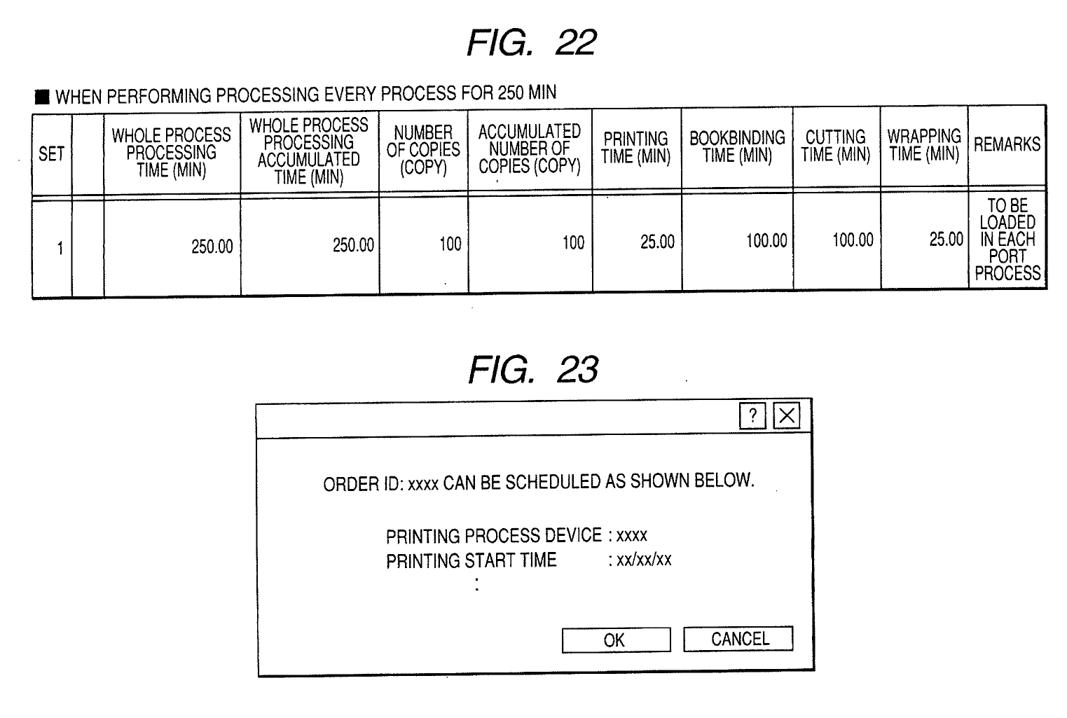

Moreover, the printing process control apparatus 709 prepares a scheduling plan by calculating the processing time of each process. Specifically, the apparatus 709 calculates the time for printing 100 copies from the information on the number of pages of a purposed job, finished size, color mode and the like and the information on the throughput (printing speed) and the maximum loading amount of a purposed printing process device. Then, the time for processing 100 copies is calculated from the information on the throughput (processing speed) of a post-process device for the information on the number of pages and finished size of a purposed job. In this case, as shown in FIG. 22, it is assumed that the time for printing 100 copies is 25.00 min., the time for bookbinding 100 copies is 100.00 min, the time for cutting 100 copies is 100.00 min and the time for wrapping 100 copies every 20 copies five times is 25.00 min.

Then, the printing process control apparatus 709 determines whether the scheduling plan in order of each process can be entered from the information in the device schedule information table (FIG. 20) (S708). When the printing process control apparatus 709 determines that the scheduling plan in order of each process cannot be entered from a device reservation situation, the apparatus 709 determines whether there is another printing process device suitable for job information from the information in the device ability information table (FIG. 21) (S709). When the printing process control apparatus 709 determines that there is another printing process device, the apparatus 709 returns to S705, selects another printing process device or another post-process device and prepares another scheduling plan in order of each process. In S709, when the printing process control apparatus 709 determines that there is not another printing process device, the apparatus 709 analyzes the reason that scheduling is impossible, notifies an operator that the reason that scheduling is impossible by the warning dialog shown in FIG. 15 (S710) and completes the processing.

However, In the case of the entry advisability determination processing in S708, when the printing system 709 determines that the scheduling plan in order of each process can be entered from the device reservation situation, the printing process control apparatus 709 obtains the security information of the selected job (order) by referring to the order information table (FIG. 19) (S711).

Then, the printing process control apparatus 709 determines whether “high” is set to the job security attribute of the selected job (S712). When the printing process control apparatus 709 determines that “high” is not set to the job security attribute, it communicates the scheduling content decided by the notice dialog shown in FIG. 23 to the operator (S713).

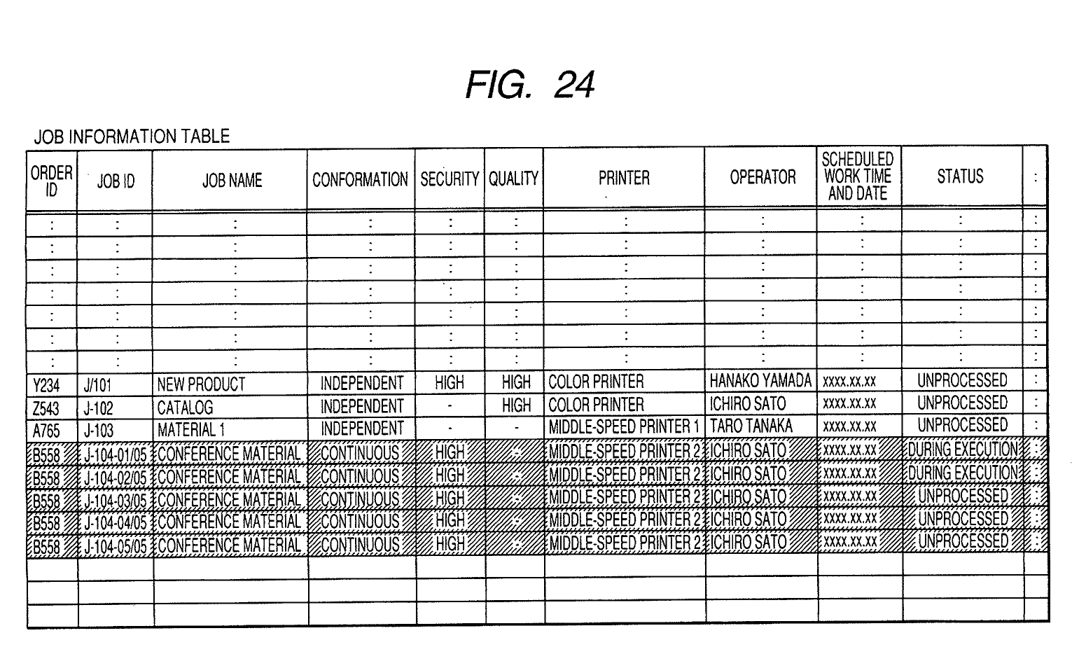

Then, the printing process control apparatus 709 stores the information on the scheduling plan in order of each process prepared in S707 in the job information table shown in FIG. 24 (S714) and completes the processing. Thus, scheduling is completed and the operator can confirm the content of the scheduling by the job list dialog shown in FIG. 13.

In the case of the security attribute determination processing in S712, when the printing process control apparatus 709 determines that “high” is set to the job security attribute, it moves to S(step) 801. In the case of a secure job in which “high” is set to a job security attribute, this represents that security protection, consideration of information leak and concealment property on the content of printed matter are requested from a customer.

Then, a scheduling method by division conformation of the present invention when purposing a secure job is described below.

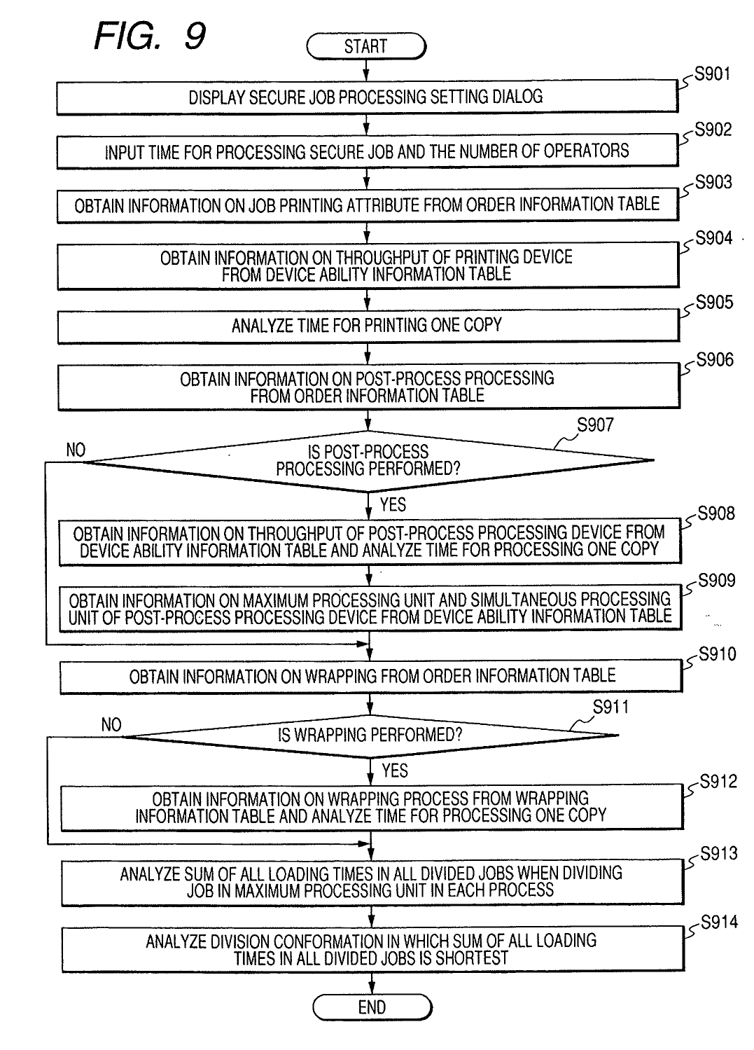

The printing process control apparatus 709 analyzes the division conformation of a job for improving the security of the job (S801). The analysis method of the division conformation of the job in S801 will be described later by referring to FIG. 9.

The printing process control apparatus 709 prepares a scheduling plan by the division conformation analyzed in S801 on the basis of the scheduling plan in order of each process (S802). The scheduling by the division conformation in this case denotes the printing process of the present invention shown in FIG. 18 differently from the work flow conformation performed by a prior art shown in FIG. 17.

For example, it is assumed to divide a job of finally preparing 100 copies into 20 copies×5 times (5 sets). First, 20 copies are printed by a printing process device (monochromatic printer A). Thereafter, saddle stitch bookbinding which is a post-process is applied to the 20 copies by a bookbinder, cutting is done by a cutting machine to complete final output products of the 20 copies up to the final process by finally applying wrapping to the 20 copies. 100 final output products up to the final process are completed through scheduling for continuously performing 5 sets every 20 copies by assuming a series of processings until 20 final products are completed as one set.

Then, the printing process control apparatus. 709 determines whether a scheduling plan according to division conformation can be entered from the information in the device schedule information table (FIG. 20) (S803). When the printing process control apparatus 709 determines that the scheduling plan according to division conformation can be entered from the device reservation situation by referring to the device schedule information table, it communicates the scheduling content decided by the notice dialog shown in. FIG. 23 to an operator (S807).

Processings from S804 to S806 when the printing process control apparatus 709 determines that the, scheduling plan according to division conformation cannot be entered from the device reservation situation in the entry advisability determination processing in S803 will be described later.

Then, the printing process control apparatus 709 determines whether the scheduling plan is OK by the notice dialog shown in FIG. 23 (S808). In this case, when an operator selects an OK button by using the keyboard 206 in FIG. 4 in the notice dialog shown in FIG. 23, it is determined that the scheduling plan is OK. When the operator, selects a cancel button, it is determined that the scheduling plan is NG. When the printing process control apparatus 709 determines that the scheduling plan is not OK, it returns to S709. However, when the printing process control apparatus 709 determines that the scheduling plan is OK, it stores the information on the scheduling plan according to division conformation prepared in S802 in the job information table (FIG. 24) (S809), stores the information showing that adjustment is impossible in the job information table (FIG. 24) as idle-time using information (S810) and completes the processing.

The processing, in S810 for storing the information showing the idle-time using information cannot be adjusted represents that the idle time of a device generated when a secure job divides the number of copies and repeatedly processes the number of copies is set so that it cannot be used for other jobs. For example, in the case of the scheduling of the printing process device (monochromatic printer A which is a middle-speed printer), bookbinder and cutting machine in FIG. 18, idle time is generated between the n-th set job Job-se n/5 and the (n+1)-th set job Job-se(n+1)/5 (n is integer of 1 to 4). If scheduling is made so that the idle time is used for other jobs, a job after the idle time is influenced, by progress or delay of other jobs and unexpected loading/leaving time of output product may occur. Therefore, it is possible to improve the certainty of secure job execution by setting the fact that the idle-time using information cannot be adjusted and the using reservation by other jobs cannot be made.

Then, an analysis method of division conformation of a job when purposing the secure job in S801 is described below by referring to the flowchart in FIG. 9.

The printing process control apparatus 709 displays the secure-job-processing setting dialog shown in FIG. 16 in S(step) 901. An operator inputs a work time and date and the number of operators working at the same time from a secure-job-processing setting dialog by using the keyboard 206 or the like in FIG. 4 (S902). In this case, it is assumed that the work time and date is set to 13:00-17:10 of 2004/03/15 (250 min), the number of operators is one are input. Then, it is assumed that the printing process control apparatus 709 holds the input information in the RAM 202 in FIG. 4.

Then, the printing process control apparatus 709 obtains the information on the printing attribute of a job by referring to the order information table (FIG. 19) and holds the information (S903). The printing process control apparatus 709 obtains the information on the throughput of a printing process device to be used by referring to the device ability information table (FIG. 21) and holds the information (S904). The printing process control apparatus 709 analyzes the time for printing one copy from the information obtained and held in S902 to S904 (S905). Specifically, the time for printing one copy is calculated from the information on the number of pages, finished size and color mode of a purposed job and the information on the throughput (printing speed) and the maximum number of loading copies of a purposed printing process device. In this case, the time for printing one copy is set to 0.25 min.

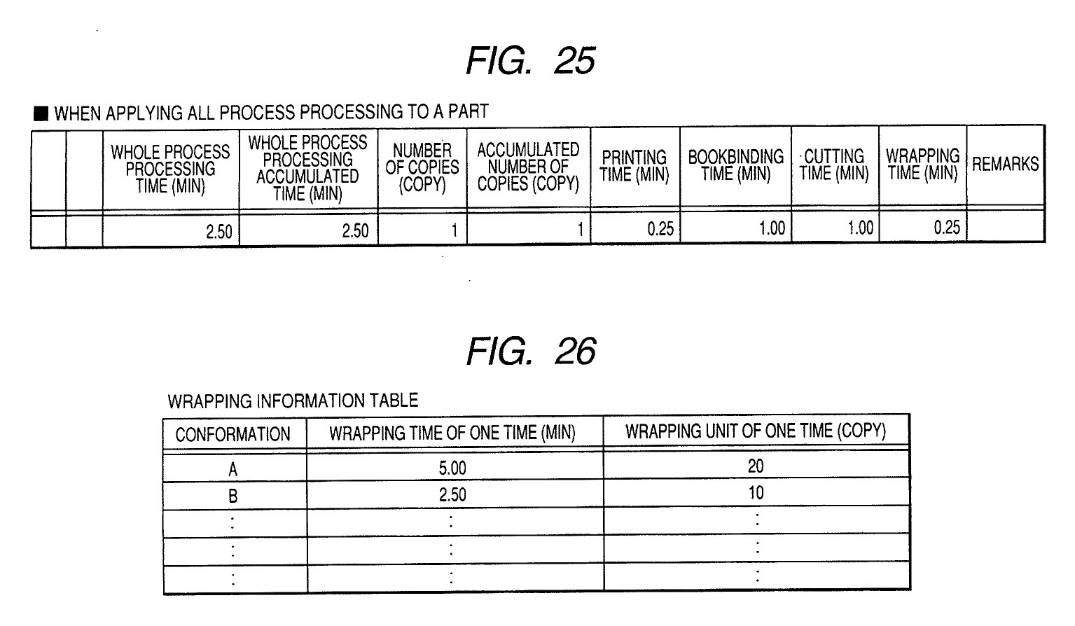

Then, the printing process control apparatus 709 obtains the information on post-process processing by referring to the order information table (FIG. 19) and holds the information (S906). The printing process control apparatus 709 determines whether to perform the post-process processing from the information obtained in S906 (S907). In S907, when the printing process control apparatus 709 determines not to perform the post-process processing, it moves to S910. In this case, it divides jobs only for the printing process. In S907, when the printing process control apparatus 709 determines to perform the post-process processing, it obtains the information on the throughput of a post-process device to be used by referring to the device ability information table (FIG. 21) and analyzes the time for processing one copy (S908). Specifically, it calculates the time for processing one copy from the information on the number of pages and finished size of a purposed job and the throughput (processing speed) of the post-process device to be used. In this case, as shown in FIG. 25, it is assumed that the time for preparing one copy is 1.00 min and the time for cutting one copy is 1.00 min.

Then, the printing process control apparatus 709 obtains the information on the maximum processing unit and batch processing unit of a post-process device to be used by referring to the device ability information table (FIG. 21) (S909). Specifically, the maximum processing unit represents the maximum number of copies which can be simultaneously set to a bookbinder. When printing of 15 copies is completed and the post-process is performed by a bookbinder having the maximum processing unit of 10 copies, sheets for 10 copies are simultaneously set to a bookbinder and remaining sheets for 5 copies are loaded/left as they are. However, when printing of 15 copies is completed and the post-process is performed by a bookbinder having the maximum processing unit of 20 copies, the copies are not loaded/left as they are because it is possible to set all the sheets for 15 copies to the bookbinder. Moreover, the batch processing unit represents the unit number of copies which can be processed only by, the unit. When printing of 15 copies is completed and the wrapping process of a batch processing unit of 10 copies is performed, sheets of 10 copies are simultaneously wrapped and remaining sheets for 5 copies are loaded/left as they are. However, when printing of 15 copies is completed and wrapping of a batch processing unit of 15 copies is performed, the copies are not loaded/left as they are because it is possible to wrap sheets for 15 copies at the same time. In this case, it is assumed that the maximum processing unit of a bookbinder is 10 copies, the maximum processing unit of a cutting machine is 20 copies and the batch processing unit of wrapping is 20 copies.

Then, the printing process control apparatus 709 obtains the information on wrapping by referring to the order information table (FIG. 19) and holds the information (S910). The printing process control apparatus 709 determines whether to perform wrapping from the information obtained in S910 (S911). In S911, when the printing process control apparatus 709 determines not to perform wrapping, it moves to S913. In this case, the wrapping process is out of an object for division. In S911, when the printing process control apparatus 709 determines to perform wrapping, it obtains the information on the wrapping process by referring to the wrapping information table shown in FIG. 26 and analyzes the time for processing one copy (S912). Specifically, 20 copies are obtained as wrapping unit of one time and 5.00 min (conformation A) is obtained as wrapping time of one time to calculate the time for processing one copy from the information. In this case, it is assumed that the time is 0.25 min as shown in FIG. 25.

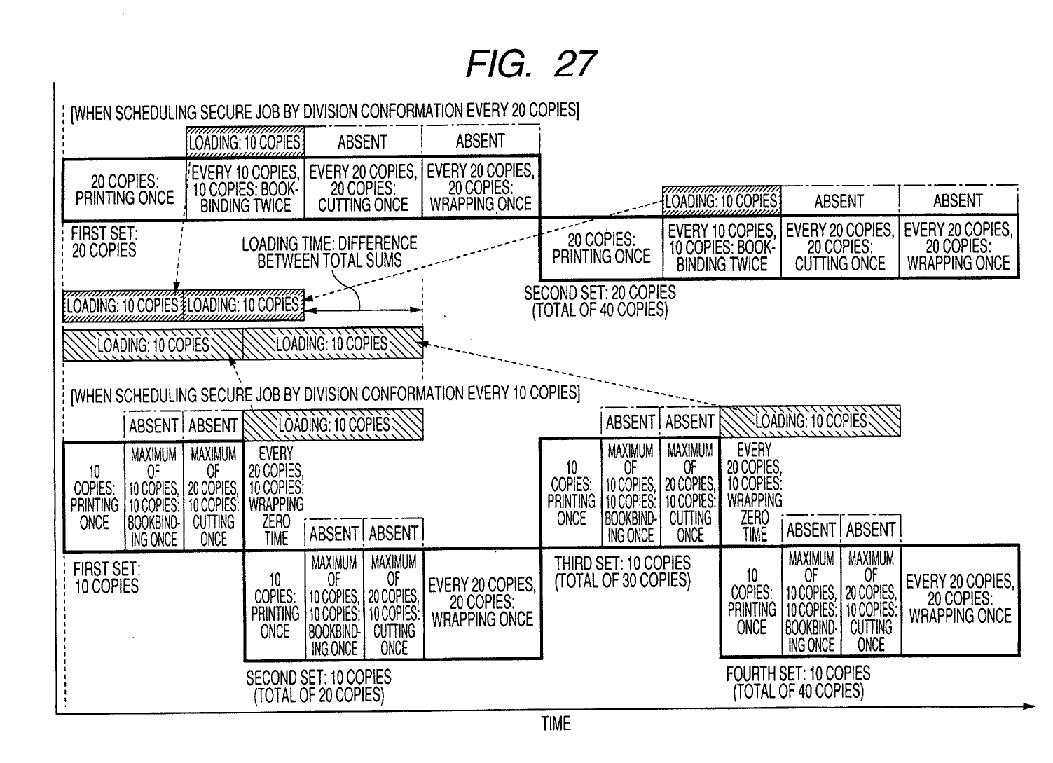

Then, the printing process control apparatus 709 analyzes the total sum of the whole loading time in all divided jobs when dividing jobs by the maximum processing unit in each process (S913). Specifically, the apparatus 709 analyzes the total sum of the whole loading time when dividing jobs by using 10 copies which is the maximum processing unit of a bookbinder and the total sum of the whole loading time when dividing jobs by using 20 copies which is the maximum processing unit of a cutting machine. The middle stage of FIG. 27 shows the total sum of the whole loading time when dividing jobs by using 10 copies which is the maximum processing unit of a bookbinder and the total sum of the whole loading time when dividing jobs by using 20 copies which is the maximum processing unit of a cutting machine.

When dividing jobs by using 10 copies which is the maximum processing unit of a bookbinder (lower stage of FIG. 27), the time in which copies are loaded/left as they are does not occur until cutting of 10 copies of the first set is completed because the bookbinding process and cutting process can perform processing every 10 copies. However, because the wrapping process performs processing every 20 copies, the time in which copies are loaded/left as they are occurs from the time when cutting of 10 copies of the first set is completed until the time when cutting of 10 copies of the second set (20th copy) is completed. That is, until 20 copies which can be wrapped can be cut, the loading/leaving time occurs once for two sets. For example, the total sum of the whole loading time which occurs until completion of 40 copies (four sets) occurs for two times as shown in the lower side of the middle stage in FIG. 27.

However, when jobs are divided by using 20 copies which is the maximum processing unit of a cutting machine (upper stage in FIG. 27), the time in which copies are loaded/left as they are occurs during bookbinding because processing can be made every 10 copies in the bookbinding process. However, because processing can be made every 20 copies in the cutting process and wrapping process, the time in which copies are loaded/left as they are does not occur. That is, the time in which copies are loaded/left as they are occurs only in the bookbinding process. The loading/leaving time occurs once for one set. For example, the total sum of the whole loading time which occurs until completion of 40 copies (two sets) occurs for two times as shown in the upper side of the middle stage in FIG. 27.

It is allowed to apply any one of a method for the printing process control apparatus 709 to optionally set previously, a method for an operator to set when selecting an order and a method for automatically deciding from the number of copies for an order to the purposed number of sets (total number of sets) when comparing total sums of the whole loading time.

Then, the printing process control apparatus 709 analyzes a division conformation closest to the total sum of the whole loading time in all divided jobs (S914). Specifically, the apparatus 709 compares the total sum of the whole loading time in each division conformation as shown at the middle stage in FIG. 27. For example, as shown in FIG. 27, in the case of the total sum of the whole loading time in all divided jobs when 40 copies are completed, it is determined that the loading/leaving time becomes short when diving jobs every 20 copies. That is, when the loading/leaving time becomes short, it is possible to improve security.

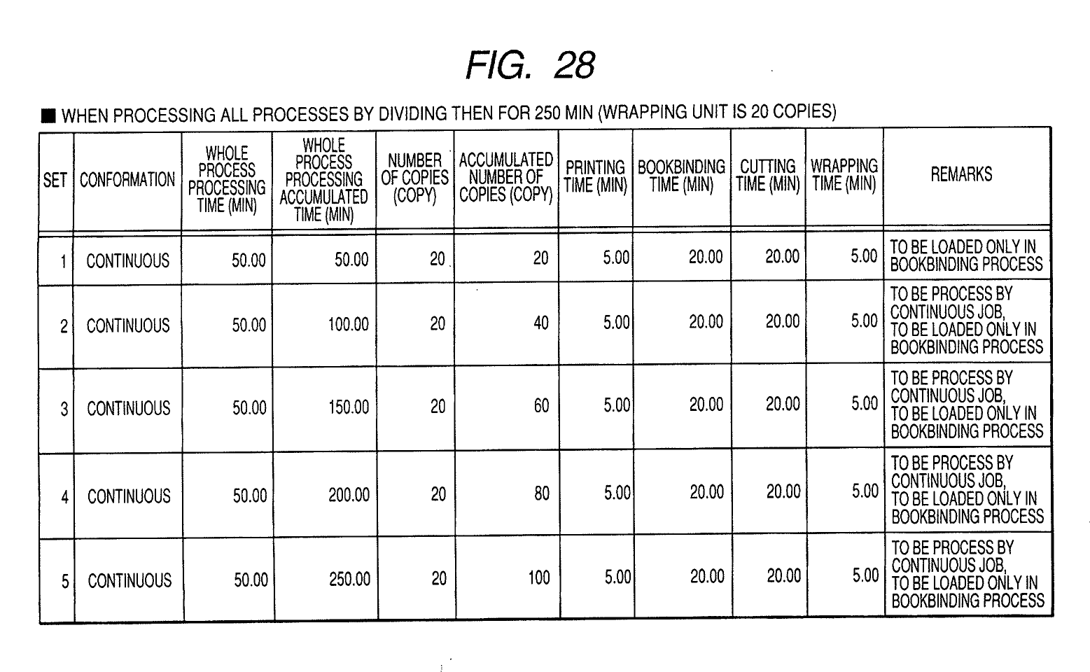

When dividing jobs every 20 copies which is a result analyzed in S914, the division conformation and processing times in each process and all processes are obtained as shown in FIG. 28. The printing process control apparatus 709 prepares a scheduling plan by a division conformation in the above-described S802.

In this case, by using the job of “order ID:B558” to which “high” is set as a job security attribute and which is a secure job, a difference between the loading/leaving time when performing scheduling in order of process which is a prior art and the loading/leaving time when performing scheduling by a division conformation of the present invention is described.

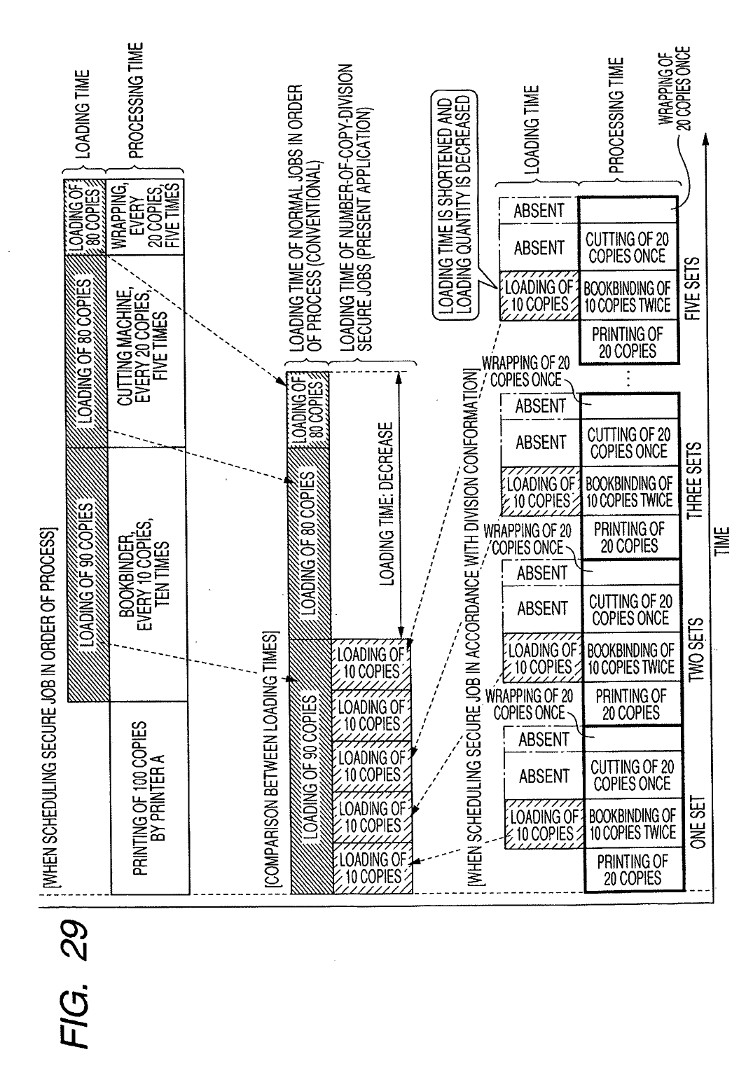

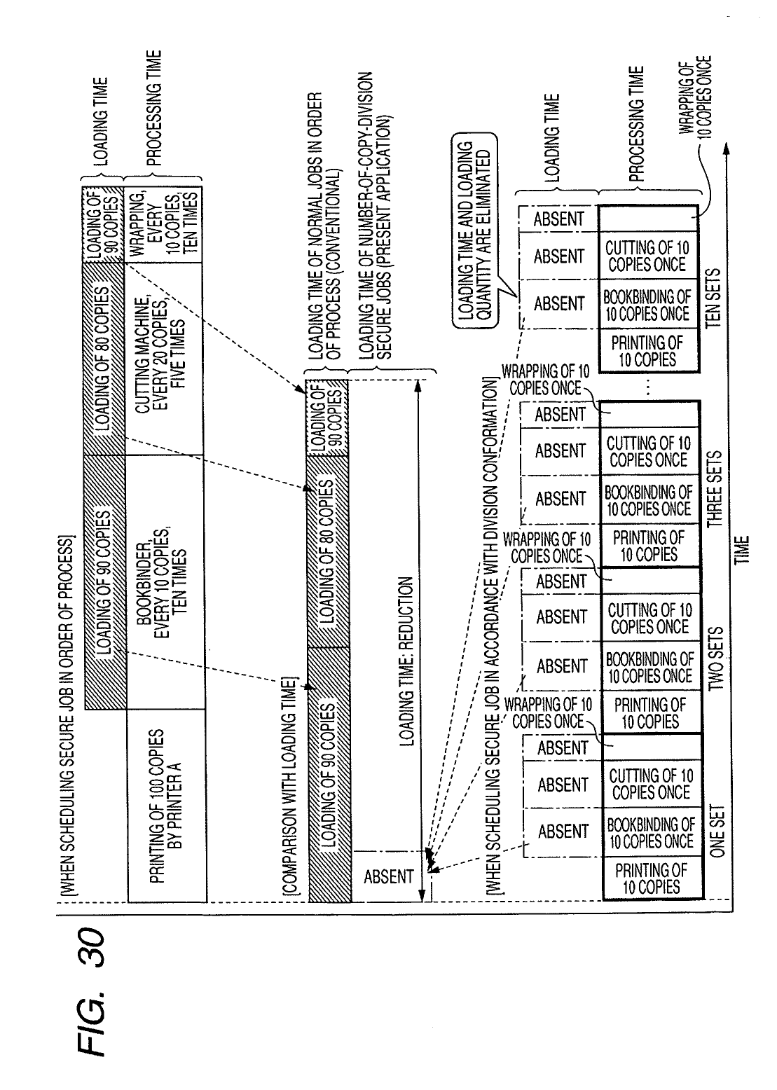

First, FIG. 29 shows the difference when the batch processing unit of the wrapping process is 20 copies and output products of 100 copies are completed. When performing scheduling in order of process which is a prior art (upper stage in FIG. 29), the loading/leaving time continuously occurs for a long time in all of the bookbinding process, cutting process and wrapping process. However, when performing scheduling in accordance with a division conformation (lower stage in FIG. 29), the loading/leaving time occurs only in the bookbinding process. Moreover, because of discontinuous loading/leaving, the time of one time is short. When comparing, the accumulated times, it is possible to shorten the loading/leaving time by performing scheduling in accordance with a division conformation (lower side) as shown at the middle stage in FIG. 29. That is, by performing scheduling in accordance with the division conformation and shortening the loading/leaving time, it is possible to improve security.

Moreover, the difference when the batch processing unit of the wrapping process is 10 copies and output products of 100 copies are completed is shown in FIG. 30. When performing scheduling in order of process which is a prior art (upper stage in FIG. 30), the loading/leaving time continuously occurs for a long time in all of the bookbinding process, cutting process and wrapping process. This is the same as the case in which the batch processing unit of the wrapping process is 20 copies. However, when performing scheduling in accordance with a division conformation (lower stage in FIG. 30), the loading/leaving time does not occur in any process. When comparing the accumulated times, it is possible to greatly reduce the loading/leaving time by performing scheduling in accordance with a division conformation as shown at the middle stage in FIG. 30. That is, by performing scheduling in accordance with a division conformation and shortening the loading/leaving time, it is possible to greatly improve security.

Scheduling is considered in which two operators are input to the number of operators in S902 and two operators can process the printing process and post-processing process in parallel.

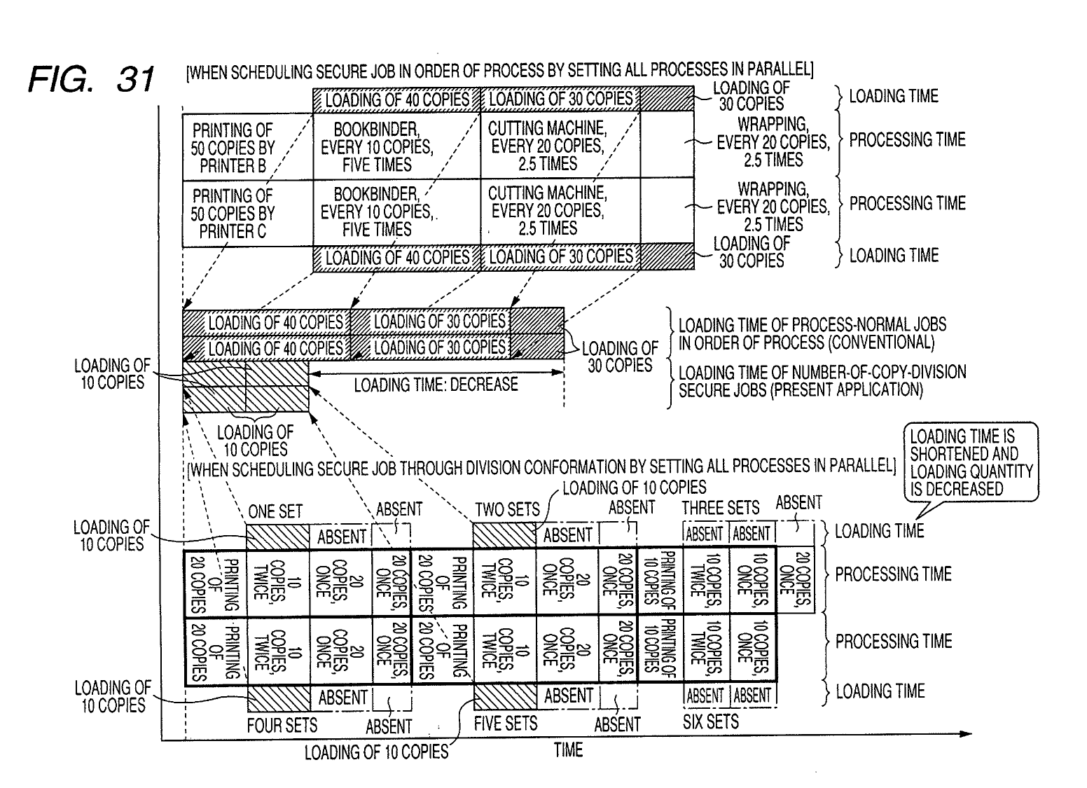

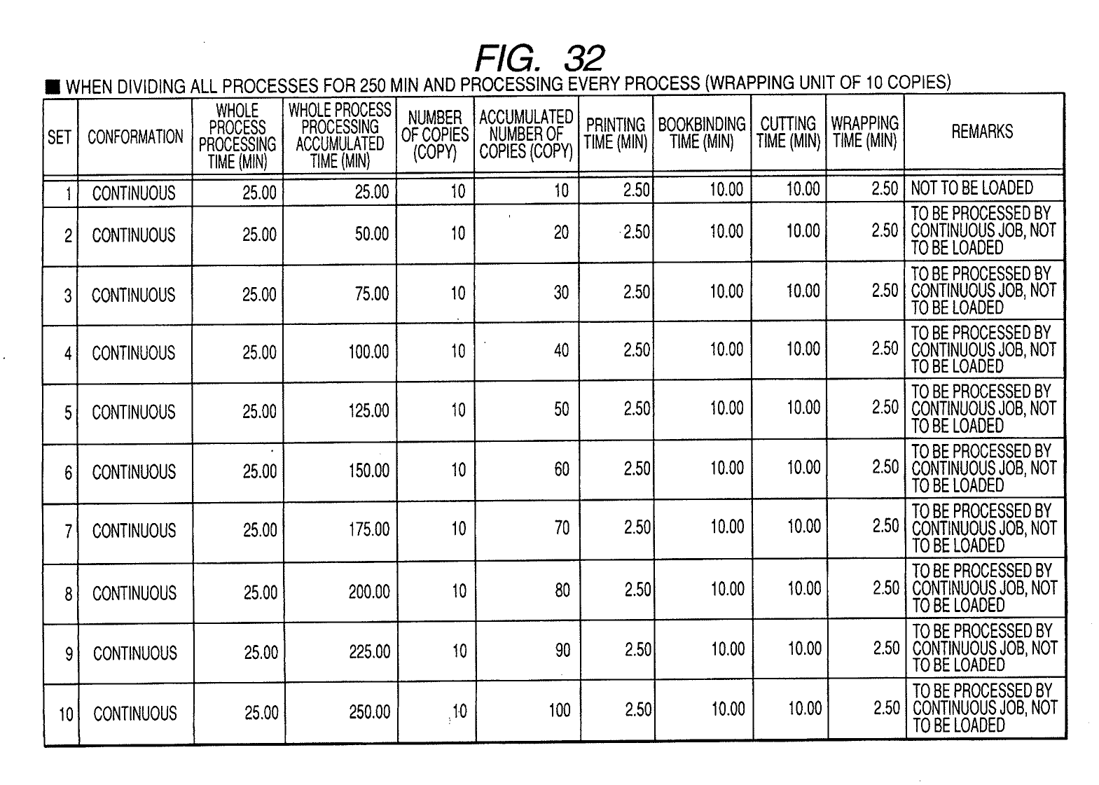

In this case, the difference between loading/leaving times is shown in FIG. 31. Even if parallel processing is possible, when performing scheduling in order of process which is a prior art (upper stage in FIG. 31), the loading/leaving time continuously occurs for a long time in all of the bookbinding process, cutting process and wrapping process. However, when performing scheduling in accordance with a division conformation (lower stage in FIG. 31), the loading/leaving time occurs only in the bookbinding process. When comparing total sum times, it is possible to greatly shorten the loading/leaving time by performing scheduling in accordance with the division conformation (lower side) as shown at the middle stage in FIG. 31. That is, even in a state capable of performing parallel processing, it is possible to improve security by performing scheduling in accordance with the division conformation and shortening the loading/leaving time.

Moreover, a case is considered in which the batch processing unit of wrapping in an order is set to 10 copies.

In this case, as shown in FIG. 30, the loading/leaving time does not occur. Therefore, it is analyzed that jobs are divided every 10 copies in S914. In this case, the division conformation and processing times in each process and all processes shown in FIG. 32 are obtained. The printing process control apparatus 709 prepares a scheduling plan according to a division conformation in S802 by using the above information. That is, it is possible to improve security by eliminating the loading/leaving time by the scheduling plan according to the division conformation.

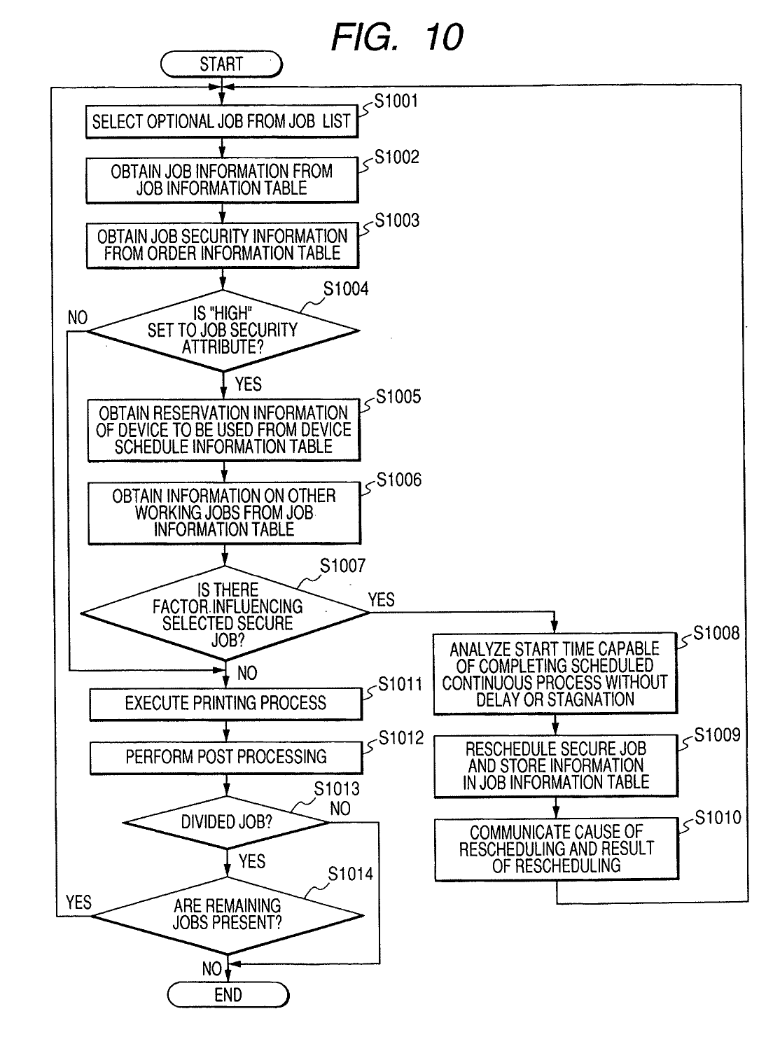

Then, execution of a job when purposing a secure job is described by referring to the flowchart in FIG. 10.

In S(step) 1001, when an operator first designates an optional job from the job list displayed on the job list dialog shown in FIG. 13, the printing process control apparatus 709 selects the designated job. In this case, the job of “order ID:B558” is selected.

Then, the printing process control apparatus 709 refers to the job information table (FIG. 24) to obtain job information (S1002). The printing process control apparatus 709 obtains job security information from the order information table. (FIG. 19) (S1003). “High” is set to the selected job of “order ID:B558” as a job security attribute and the selected job is a secure job.

Then, the printing process control apparatus. 709 determines whether “high” is set to the job security attribute from the referenced information (S1004). When the printing process control apparatus, 709 determines that “high” is not set to the job 25 security attribute, it moves to S1011 to perform the printing process. When the printing process control apparatus 709 determines that “high” is set to the job security attribute, it refers to the device schedule information table (FIG. 20) to obtain the reservation information of a device to be used and holds the information (S1005).

In the case of this example, because the job of “order ID:B558” is selected in S1001, the apparatus 709 determines that “high” is set to the job security attribute. Therefore, the printing process control apparatus 709 executes S1005 and then refers to the job information table (FIG. 24) to obtain the information on other jobs in service (S1006).

Then, the printing process control apparatus 709 determines whether there is a factor influencing the selected secure job from the reservation information on devices and the information on jobs in service (S1007). When the printing process control apparatus 709 determines that there is a factor influencing the selected secure job, it moves to S1008. If printing the secure job when the apparatus 709 determines that there is a factor influencing the secure job, the unexpected loading/leaving time of a printed matter may occur. For example, when a post-process device to be used by the secure job is used for an other job which previously works and the work is delayed and the use completion time of the post-process device is delayed by an other job, the time for the secure job to start use is delayed and the loading/leaving time of the printed matter may occur. Therefore, security is improved by performing processings on and after S1008.

In S1008, the printing process control apparatus 709 refers to the device schedule information table (FIG. 20) and analyzes the start time at which a continuous process scheduled through number-of-copy division can be completed without delay or stagnation (S1008). The printing process control apparatus 709 reschedules the secure job in accordance with the analysis result in S1008 and stores the information in the job information table (FIG. 24) (S1009). The printing process control apparatus 709 communicates the rescheduled cause and result to an operator by the communication dialog shown in FIG. 23 (S1010) and returns to S1001.

When the printing process control apparatus 709 determines that there is not a factor influencing the selected secure job in S1007, it performs the printing process (S1011). Specifically, the printing designation dialog shown in FIG. 14 is displayed and the operator completes setting of a setting screen and then presses “OK” button and thereby, printing data is output to a printing-process device and printing is started.

Then, the operator processes the post-process when the printing process is completed (S1012). In this case, because “order ID:B558” is selected in S1001, bookbinding, cutting and wrapping are performed in the post process. Specifically, as shown in FIG. 29, 20 copies are printed in the printing process, processed every 10 copies twice in the bookbinding process and processed every 20 copies once in the cutting process and processed every 20 copies once in the wrapping process and the first set is completed.

Then, the printing process control apparatus 709 refers to the job information table (FIG. 24) to obtain job information and determines whether the information is a divided job (S1013). When the printing process control apparatus 709 determines that the information is not a divided job, it completes the processing. When the printing process control apparatus 709 determines that the information is a divided job in S1013, it determines whether remaining jobs are present (S1014). When the apparatus 709 determines that no remaining job is present by referring to the job information table shown in FIG. 24, the apparatus 709 completes the processing. When the printing process control apparatus 709 determines in S1014 that remaining jobs are present, it returns to S1001 and repeats S1001 to S1014 and sequentially processes the second set and third set. Then, the apparatus 709 completes all jobs.

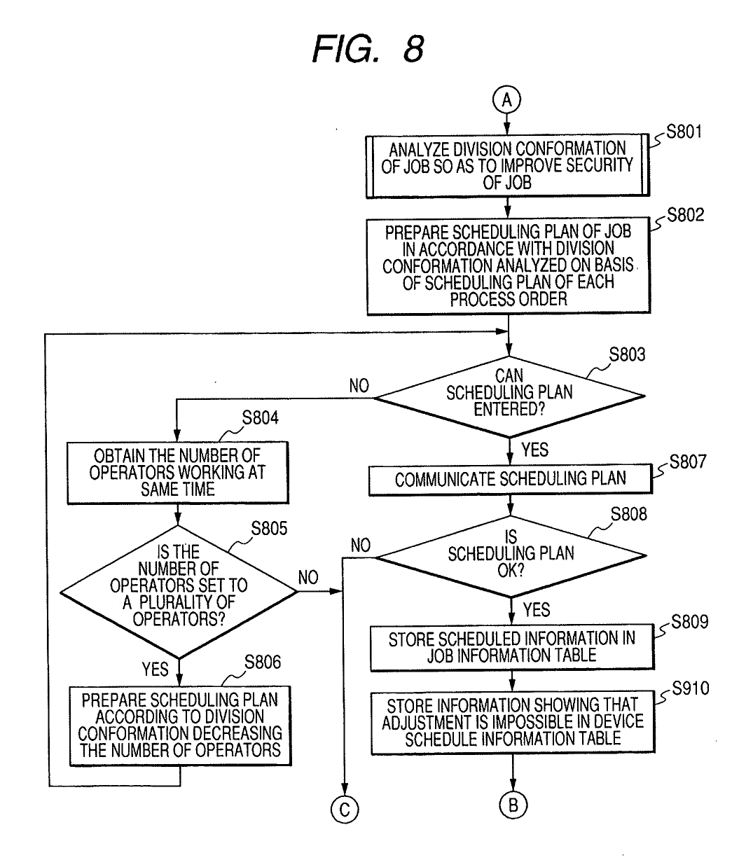

Finally, the processing when the printing process control apparatus 709 determines in S803 in FIG. 8 that a scheduling plan according to a division conformation cannot be entered is described below.

In S803, the printing process control apparatus 709 obtains the information on the number of operators simultaneously working held by the printing process control apparatus and input by an operator in S902 from the RAM 202 in FIG. 4 (S804). The printing process control apparatus 709 determines whether the number of operators is set to a plurality of operators (S805). When the printing process control apparatus 709 determines that the number of operators Is not set to a plurality of operators, it moves to S709.

When the printing process control apparatus 709 determines in S709 that there is another printing process device, it returns to S705, selects another printing process device or post-process device and prepares another scheduling plan in order of process. Then, the apparatus 709 processes S801 again via S712, prepares a scheduling plan according to another division conformation in S803 and determines S803.

When the printing process control apparatus 709 determines in S805 that the number of operators is set to a plurality of operators, it prepares a scheduling plan according to a division conformation in which the number of operators is decreased by one. Then, the apparatus 709 returns to S803 to determine whether the scheduling plan can be entered. Thereby, by performing scheduling according to a division conformation in accordance with a conformation of all process parallel processing as much as possible, it is possible to improve both security and work efficiency for a secure job.

### Other Embodiment

As described above, it is allowed to apply the present invention to a system constituted of a plurality of units (for example, host computer, interface unit, reader and printer) or an apparatus constituted of one unit (for example, copying machine or facsimile apparatus).

Moreover, the category of the present invention includes an object executed by supplying the program code of software for realizing the embodiment function to a computer in an apparatus or system connected with various devices so as to operate the devices so as to realize the embodiment function described above and operating the various devices in accordance with the program stored in the computer of the system or apparatus (CPU or MPU).

In this case, the program code itself of the software realizes the above embodiment function and the program code itself and means for supplying the program code to the computer such as a storage medium storing the program code constitutes the present invention.

As a storage medium for storing the program code, it is possible to use a floppy (registered trademark) disk, hard disk, optical disk, magneto-optical disk, CD-ROM, magnetic tape, nonvolatile memory card or ROM.

Moreover, by executing the program code supplied to the computer, not only the embodiment function described above is realized but also the program code is included in the embodiments of the present invention when the program code collaborates with an OS (operating system) working in the computer or other application software.

Moreover, a case is also included in the present invention, in which the supplied program code is stored in the memory of a function expansion board of the computer or a function expansion unit connected to the computer and then, a CPU included in the function expansion board or a function storing unit performs a part or all of the actual processing and the embodiment function is realized by the processing.

As many apparently widely different embodiments of the present invention can be made without departing from the spirit and scope thereof, it is to be understood that the invention is not limited the specific embodiments thereof except as defined in the appended claims.

According to a printing process control apparatus having the above configuration, program, recording medium and printing process control method for controlling the process of the printing process control apparatus, when scheduling order data (job), it is possible to decrease the loading/leaving time of a job and improve the security when executing a job by dividing the order data into a plurality of jobs so that printing by a printer and succeeding post-processing by a post-processing apparatus are temporally continuously assigned.

Moreover, by applying job division to a secure job from which an original should be concealed during processing, it is possible to improve the security under execution of the secure job.

Furthermore, by determining possible or impossible of assignment of a preceding process in accordance with the state of another job and the idle state of a succeeding process, it is possible to improve the certainty of job execution.

Furthermore, by realizing parallel processing by a plurality of operators, it is possible to improve the efficiency of secure job execution.

This application claims priority from Japanese Patent Application No. 2005-042526 filed Feb. 18, 2005, which is hereby incorporated by reference herein.

What is claimed is:

1. A printing process control apparatus for controlling a schedule of a printing process by a printer and a schedule of post-processing process by a post-processing apparatus, comprising:
a job division unit adapted to analyze order data for designating the number of prints of an original to be printed by the printer and a post-processing condition and divides the order data into a plurality of processing-process jobs; and
a schedule decision unit adapted to assign the plurality of processing process jobs divided by said job division unit respectively as the processing by the printer and the post-processing by the post-processing apparatus and decide a schedule,
wherein said schedule decision unit decides a schedule so that a combination of the printing by the printer and the post-processing by the post-processing apparatus is repeatedly performed.

2. The printing process control apparatus according to claim 1, further comprising a storage unit adapted to store at least the throughput of the post-processing apparatus, wherein said schedule decision unit divides the order data into a plurality of processing-process jobs in accordance with the throughput of the post-processing apparatus stored in said storage unit.

3. The printing process control apparatus according to claim 1, wherein said job division unit includes an attribute determination unit adapted to determine whether the order data is security set and perform job division for the order data determined as the fact that it is security-set.

4. The printing process control apparatus according to claim. 1, further comprising a second storage unit adapted to store schedule assignment states of the printer and post-processing apparatus, wherein said schedule decision unit includes an assignment determination unit adapted to determine advisability of assignment of a preceding process in the processing process jobs in accordance with the reservation state of other processing process job obtained from the reservation state stored in said second storage unit and the idle state of a succeeding process and decide the schedule of each of the processing process jobs in accordance with the assignment determination result.

5. The printing process control apparatus according to claim 1, further comprising an output unit adapted to output the original data of an original to be printed in order to prepare printed matter in accordance with the scheduled processing to the printer.

6. The printing process control apparatus according to claim 1, wherein said schedule decision unit decides a schedule in order to perform preceding processing-combination post-processing process jobs divided by said job division unit and a succeeding processing-combination printing process job in parallel.

7. The printing process control apparatus according to claim 1, further comprising:
a communication unit adapted to communicate with a client apparatus through a network; and
an order obtainment unit adapted to obtain the order data from the user input from the client apparatus through said communication unit.

8. A printing process control method in a printing process control apparatus for controlling a schedule of a printing process by a printer and a schedule of a post-processing process by a post-processing apparatus, comprising;
a job division step of analyzing order data for designating the number of prints of an original to be printed by the printer and a post-processing condition and dividing the order data into a plurality of processing process jobs; and
a schedule decision step of assigning the plurality of processing process jobs divided it the job division step as the printing by the printer and the post-processing by the post-processing apparatus and deciding a schedule,
wherein the schedule decision step decides the schedule so that a combination of the printing by the printer and the post-processing by the post-processing apparatus is repeatedly performed.

9. The printing process control method according to claim 8, further comprising a storage step of storing at least the throughput of the post-processing apparatus, wherein the schedule decision step divides the order data into a plurality of processing-process jobs in accordance with the throughput of a post-processing apparatus stored in the storage step.

10. The printing process control method according to claim 8, wherein the job division step includes an attribute determination step for determining whether the order data is security set and performs job division for the order data determined as the fact that it is security-set.

11. The printing process control method according to claim 8, further comprising a second storage step of storing schedule assignment states of the printer and the post-processing apparatus, wherein the schedule decision step includes an assignment determination step for determining advisability of assignment of a preceding process in the processing process jobs in accordance with the reservation state of other processing process job obtained from the reservation state stored in the second storage step and the idle state of a succeeding process and decides the schedule of each of the processing process jobs in accordance with the assignment determination result.

12. The printing process control method according to claim 8, further comprising an output step of outputting the original data of an original to be printed in order to prepare printed matter in accordance with the scheduled processing to the printer.

13. The printing process control method according to claim 8, wherein the schedule decision step decides a schedule in order to perform preceding processing-combination post-processing process jobs divided in the job division step and a succeeding processing-combination printing process job in parallel.

14. The printing process control method according to claim 8, further comprising:
a communication step of communicating with a client apparatus through a network; and
an order obtainment step of obtaining the order data from the user input from the client apparatus through the communication step.

15. A storage medium storing a printing process control program to be executed by a printing process control apparatus for controlling a schedule of a printing process by a printer and a schedule of a post-processing process by a post-processing apparatus, the printing process control program comprising:
a job division step of analyzing order data for designating the number of prints of an original to be printed by the printer and a post-processing condition and dividing the order data into a plurality of processing process jobs; and
a schedule decision step of assigning the plurality of processing process jobs divided in the job division step as the printing by the printer and the post-processing by the post-processing apparatus and deciding a schedule,
wherein the schedule decision step decides a schedule so that a combination of the printing by the printer and the post-processing by the post-processing apparatus is repeatedly performed.

16. The storage medium according to claim 15, further comprising a storage step of storing at least the throughput of the post-processing apparatus, wherein the schedule decision step divides the order data into a plurality of processing-process jobs in accordance with the throughput of a post-processing apparatus stored in the storage step.

17. The storage medium according to claim 15, wherein the job division step includes an attribute determination step for determining whether the order data is security-set and performs job division for the order data determined as the fact that it is security-set.

18. The storage medium according to claim 15, further comprising a second storage step of storing schedule assignment states of the printer and the post-processing apparatus, wherein the schedule decision step includes an assignment determination step for determining advisability of the assignment of a preceding process in the processing process jobs in accordance with the reservation state of other processing process job obtained from the reservation state stored in the second storage step and the idle state of a succeeding process and decides the schedule of each of the processing process jobs in accordance with the assignment determination result.

19. The storage medium according to claim 15, further comprising an output step of outputting the original data of an original to be printed in order to prepare printed matter in accordance with the scheduled processing to the printer.

20. The storage medium according to claim 15, wherein the schedule decision step decides a schedule in order to perform preceding processing combination post-processing process jobs divided in the job division step and a succeeding processing combination printing process job in parallel.

21. The storage medium according to claim 15, further comprising:
a communication step of communicating with a client apparatus through a network; and
an order obtainment step of obtaining the order data from the user input from the client apparatus through the communication step.
